(19) United States
(12) Patent Application Publication
(10) Pub. No.: US 2011/0188645 A1
(43) Pub. Date: Aug. 4, 2011

(54) Telephone call handling system

(76) Inventor: Christopher Guy Williams, Spokane, WA (US)

(21) Appl. No.: 12/658,475

(22) Filed: Feb. 4, 2010

(51) Int. Cl. H04M 1/64

(52) U.S. Cl. 379/88.19

(57) ABSTRACT

A telephone call handling system wherein a user is provided with caller I.D. information. For responding to the information, the system affords the user a plurality of call handling options beyond the simple option of answering the call or not. The user can instruct the system to implement any one of the plurality of options. One option can send a call back message to the caller. Another option can send a hold message to the caller and then places the caller on hold. A third option can send entertainment to the caller such that user and caller can simultaneously enjoy the entertainment.

### BACKGROUND

A call screening service commonly known as “Caller I.D.” is widely utilized by present-day telephone users. Caller I.D. is a service provided to users by the telephone service providers via telephones typically fitted with a display. For calls from landline phones, the caller I.D. information typically displayed includes the telephone number of the landline phone a caller is calling from and the subscriber name documented to that number. For calls from cell phones, the information typically displayed includes the telephone number of the cell phone a caller is calling from and whatever name the cell phone owner happens to program into his phone (or not).

Present-day, telephone users having caller I.D. typically first respond to an incoming telephone call by looking at the display. They then consider that information along with their encumbrances of that moment and mood at that moment, and decide whether to answer the call or not. If not, typically after a set number of additional rings, the incoming call is automatically transferred to a voice mail service (or answering machine for many landline phones) where the caller may leave a message to be reviewed by the user at some later time.

### SUMMARY OF THE INVENTION

Caller I.D. is flawed in that the telephone number and name provided belong to the subscriber of the calling telephone. A caller wishing to circumvent caller I.D. call screening need only place the call from someone else's phone, a pay phone or an out-of-area phone or simply use their own phone and block transmission of the caller I.D. information. Conversely, often times a caller simply happens to be calling from someone else's phone, a pay phone, an out-of-area phone or a family shared phone and, thus, caller I.D. will not provide the user with the true identity of the caller.

In this ever-accelerated world, unknown/unwanted calls answered and unknown yet wanted calls not answered, all due to the shortcomings of caller I.D., costs time/productivity. U.S. Pat. No. 7,062,034 to Williams discloses an invention that cures said caller I.D. shortcomings. Williams discloses a number of embodiments where call-announce information is attained from the caller and delivered to the user. Williams describes attaining call-announce information whereby the caller is asked to speak their name. From the spoken name information and in the caller's voice, the user can readily identify the individual who's calling.

In one embodiment, Williams discloses a system whereby the user initiates the system to attain call-announce information and deliver the information to the user. This system enables the user to consider their encumbrances of that moment and mood at that moment in their decision whether to bother the caller to provide the call-announce information or not. However, if the user desires to know the identity of every caller, every caller must be inconvenienced to provide the call-announce information.

The present disclosure provides for a telephone call handling system, certain embodiments of which achieve improved utilization of caller I.D. information (improved beyond a user receiving caller I.D. information and therefrom simply deciding whether to answer the phone or not). The improved utilization of the caller I.D. information produces improved fluency and continuity to telephone call communication, saves caller and user time and enables selective entertainment of caller and/or user.

The following example description of operation of one embodiment provides one example of said greater fluidity and continuity while conserving callers and the user's time. At the onset of an incoming call, caller I.D. information is provided to the user (i.e. the party being called). From the information, the user is able to essentially determine the identity of the caller and surmises that this person cares to discuss something the user has not yet accumulated all the facts regarding. Accordingly, the user activates a call back message circuitry. A message is then sent to the caller, for example, “Please call back in twenty minutes”.

A second example description of operation of another embodiment of the present invention provides another example of said greater fluidity and continuity while saving the user's time and providing convenience to the user. The incoming call includes caller I.D. information. From the information, the user is essentially able to determine the identity of the caller. However, the user is presently occupied with other matters. Consequently, the user starts a message-then-hold circuitry. In response, the circuitry sends the message to the caller, “I'll be right with you”. The circuitry then retains connection with the caller, circuitry and caller waiting for the user to answer the call. When the user is no longer preoccupied, the user may then answer the call. Message-then-hold frees the user from the messy/uncomfortable and time consuming action of having to answering the call and notifying the caller he is to be placed on hold.

A third example description of operation of another embodiment of the present invention provides an example of enabling selective entertainment of the caller and/or user. The incoming call includes caller I.D. information. For example, from the information, the user presumes that his big brother Mike is calling. The user knows that brother Mike likes rap music. Accordingly, the user presses a concert button and, subsequently, key-six on the touch-tone keypad of his telephone. Pressing the concert button places the system in concert mode and pressing key-six picks a rap song the user has previously programmed to key-six. The system then responds by playing the key-six rap sound to both caller and user. The user then decides to answer the call. The system continues to play the music to both caller and user while they converse.

A fourth example description of operation of another embodiment of the present invention provides another example of said greater fluidity and continuity while conserving both callers and user's time. The incoming call includes caller I.D. information. From the information, the user is unable to positively identify the caller. Consequently, the user then initiates a call-announce circuitry. The circuitry attains “who” information by asking the caller “Who's calling”? The name of the caller and in the caller's voice is provided by the caller and delivered to the user. Consequently, the user now knows with certainty who's calling. The user may then decide whether to answer the call or not. In this way, only when the caller's identity cannot be essentially determined from the caller I.D. is the caller inconvenienced to provide call-announce information and is the user required to spend time listening to the call-announce information

A fifth example description of operation of another embodiment of the present invention provides another example of said greater fluidity and continuity while conserving both caller's and user's time. First, caller I.D. information is provided to the user. From the information, the user is able to essentially determine the identity of the caller. However, the user is busy and, so, the user then initiates a call-announce circuitry. The circuitry attains what/why-information by asking the caller “To best handle this call, please state why you've called”? The what/why-information provided by the caller is delivered to the user and the user may decide whether this is the most appropriate moment to answer the call and address the caller's what/why.

As can be seen, in various of the embodiments described herein above, a message or other information is provided to a caller based on caller I.D. information (or, in the alternative, based on a lack of caller I.D. information), and the message or information is provided without the called party actually answering the call. However, in each instance the called party can make an election to either answer the call or send the caller the selected message or information. This arrangement is in contrast to prior art voice message systems wherein the called telephone answers the call and plays a pre-set message irrespective of any caller I.D. information (or lack thereof). Further, the prior art voice message systems do not allow the called-party to review caller I.D. information and then make an election of a specific message or information to be transmitted back to the calling party, as do embodiments of the current invention.

### BRIEF DESCRIPTION OF THE DRAWINGS

A form of the invention is illustrated in the accompanying drawings in which:

FIGS. 1a and 1b are block diagrammatic views depicting examples of a first embodiment comprised of caller I.D. circuitry, call back message circuitry and an activator.

FIGS. 2a and 2b are block diagrammatic views depicting examples of a second embodiment comprised of caller I.D. circuitry, message-then-hold circuitry and a starter.

FIGS. 3a and 3b are block diagrammatic views depicting examples of a third embodiment comprised of caller I.D. circuitry, concert circuitry and an orchestrator.

FIG. 4 is a block diagrammatic view depicting an example of a fourth embodiment comprised of caller I.D. circuitry, call-announce circuitry configured to attain who-information, and an initiator.

FIG. 5 is a block diagrammatic view depicting an example of a fifth embodiment comprised of caller I.D. circuitry, call-announce circuitry configured to attain what/why-information, and an initiator.

FIG. 6 is a block diagrammatic view depicting an example of a sixth embodiment comprised of caller I.D. circuitry, call-announce circuitry configured to attain who-information and what/why-information, and an initiator.

FIG. 7 is a block diagrammatic view depicting a telephone service provider with the present invention located therein.

FIG. 8 is a block diagrammatic view depicting an example of a seventh embodiment comprised of caller I.D. circuitry, a plurality of complementary circuitry and an enabler.

### DETAILED DESCRIPTION

The present invention pertains to telephone calls. Accordingly, a general description of telephone service is appropriate. For decades, telephone service in the U.S. was provided by an entity commonly known as “the phone company”, “Ma Bell” and “AT&T”. Deregulation broke up the giant telephone service provider into a network of service providers then commonly referred to as “the baby bells”. For this discussion, the present-day network of service providers including the circuitry they employ is referred to as a telephone service provider 121.

One example of circuitry that can be employed in the routing of a telephone call by a service provider 121 is shown in FIG. 7. An example of operation of the example circuitry shown will now be given. The caller places a call from the caller's phone 122. That call is received at local switching station 120a, sent over long distance network 124 and received at local switching station 120. Station 120 then rings the user's telephone 27k. If telephone 27k is answered, station 120 then communicably connects phone 122 with phone 27k.

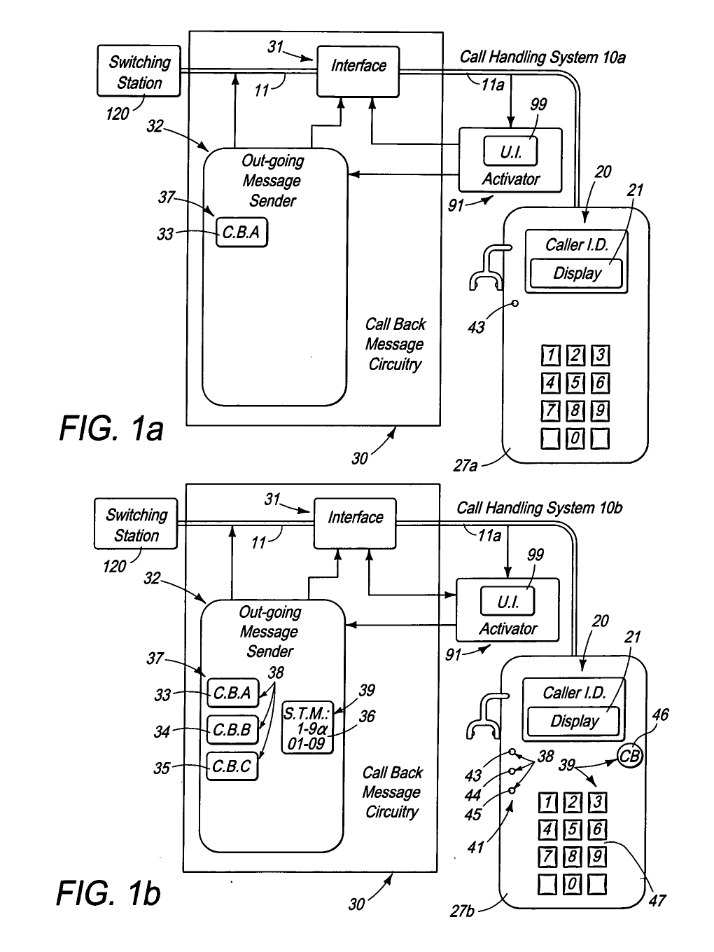

Examples of the present invention, referred to herein as telephone call handling system 10, are illustrated in the accompanying FIGS. 1a through FIG. 8. Example handling systems 10a through 10k comprise a caller I.D. circuitry 20. An example of caller I.D. circuitry 20 is shown in FIGS. 1a-8. Caller I.D. circuitry 20 functions to provide caller I.D. information to a user. Caller I.D. circuitry 20 comprises a caller I.D. display 21. To indicate the presence of an incoming call, local switching station 120 sends a ring signal to telephone 27, causing telephone 27 to ring. Along with the ring signal, switching station 120 sends caller I.D. information. The information is received at caller I.D. circuitry 20 and, subsequently, provided for a user to read on caller I.D. display 21. (Caller I.D. circuitry 20 and display 21 can comprise common-day telephony components.)

Example handling systems 10a through 10k further comprise at least one complementary circuitry. Said complementary circuitry can be employed by a user to send a response to the source of an incoming call, the source as identified (or not) by caller I.D. 20. Said complementary circuitry comprises one or more of: call back message circuitry 30, message and hold circuitry 40, concert circuitry 50, call-announce circuitry configured to attain who-information 60, call-announce circuitry configured to attain what/why-information 70 and call-announce circuitry configured to attain who and what/why information 80. Circuitry 30, 40, 50, 60, 70 and 80 shown variously in FIGS. 1a through 6 and FIG. 8 each employ an interface 31 and an out-going message sender 32.

An example of interface 31 will now be given. Interface 31 functions to control connection and release operations. Interface 31 is electrically connected to (or connectable to) line 11 and, responsive to input, can go off-hook. (“Electrically connected to” includes the capability to become electrically connected to, for example, as by way of a switch, as well as connectivity by wireless transmission such as Blue Tooth or other radio frequency or infra red-type transmission.) Handling system 10 can be located remote from service provider 121, as for example at a user location or in a user telephone 27, as depicted in FIGS. 1a through 6 and FIG. 8. Handling system 10 can also be located at service provider 121, as depicted in FIG. 7. Other arrangements for distribution and/or consolidation of the components of system 10 can also be provided, all within the scope of the present disclosure. When system 10 is located at either location, going off-hook can serve to cause service provider 121 to discontinue the sending of a ring sound to the caller's telephone and further can serve to provide that system 10 and service provider 121 are communicably connected such that message sender 32 of system 10 can send a message to the caller's telephone. When system 10 is located at either location, going off-hook can further function to discontinue the sending of a ring signal to telephone 27 and to provide that system 10 can receive information from the caller's telephone via service provider 121. (Interface 31, when located as shown in FIGS. 1a through 6 and FIG. 8, can optionally be configured to connect and disconnect two-way communication between telephone 27 and an incoming call. The two-way communication pathway can be disconnected in the case where signals sent from system 10 to telephone 27, via line 11a, and from telephone 27 to system 10 are desired not to travel back to the caller's telephone or to the service provider.)

An example of out-going message sender 32 will now be given. Out-going message sender 32 functions to send stored information to a caller. Sender 32 is electrically connected to (or connectable to) telephone line 11 and sends a message to line 11 and, thus, ultimately to the caller. (Interface 31 and out-going message sender 32 can comprise common-day telephony components.)

A first embodiment of telephone call handling system 10 is illustrated in FIGS. 1a and 1b. This first embodiment comprises the prior described caller I.D. circuitry 20. This embodiment also comprises call back message circuitry 30 and an activator 91.

An example of call back message circuitry 30 (FIGS. 1a and 1b) will now be given. Call back circuitry 30 functions to deliver a call back message to a caller. Call back circuitry 30 comprises interface 31 (described prior) and out-going message sender 32 (described prior). (Call back message circuitry 30 can comprise a common-day telephony component.)

An example of activator 91 (FIGS. 1a and 1b) will now be given. Activator 91 functions to receive instruction from a user to activate call back message circuitry 30. Activator 91 comprises a user interface (U.I.) 99. U.I. 99 functions to receive instruction from a user. (U.I. 99 can comprise common-day telephony components such as a microprocessor and memory available to the microprocessor. Activator 91 can comprise a common-day telephony component.)

A first example of this first embodiment is illustrated as system 10a in FIG. 1a. Out-going message sender 32 of call back circuitry 30 is configured to deliver to a caller a call back message C.B. A 33. C.B. A 33 states, “Please call back in one hour”. (The message, “Please call back in one hour” constitutes a specific time call back message 37, shown in FIGS. 1a and 1b. Conversely, call back messages can state, for example, “I'll call you back in one hour”.) Message sender 32 is further configured to send a signal to interface 31 at the conclusion to the sending of the message.

U.I. 99 is configured to receive instruction from a user via a control button 43, button 43 electrically connected to (or connectable to) line 11a and located at telephone 27a. When pressed, button 43 is configured to send a control signal via line 11a to U.I. 99. U.I. 99 responds by sending a signal to interface 31 and, after a two-second delay, by sending a signal to sender 32. Interface 31 responds by going off-hook. Sender 32 responds by sending message C.B. A 33 to the caller. (Button 43, and all to-be-discussed buttons, can comprise a common-day telephony component.)

An example of operation of this first example of this first embodiment will now be given. A user's telephone is rung by an incoming ring signal provided by station 120 via line 11 and line 11a. Delivered with the ring signal is caller I.D. information. The information appears on display 21 (located at telephone 27a). The user recognizes the phone number on the display; i.e. the user presumably knows who's calling. The user surmises that this person cares to discuss a matter that the user has not yet accumulated all the pertinent facts regarding and, thus, cannot conclude a successful conversation with this caller at this time. Accordingly, the user presses control button 43. Button 43 responds by sending a signal to U.I. 99 via line 11a. U.I. 99 responds by sending a signal to interface 31 and, after a two second delay, by sending a signal to out-going message sender 32. Interface 31 responds by going off-hook. Sender 32 responds by playing and sending stored message C.B. A 33, “Please call back in one hour” to the caller (via line 11 and switching station 120). The caller hears the message and understands to call back in one hour. At the conclusion to sending the message, sender 32 sends a signal to interface 31. Interface 31 responds by discontinuing the off-hook condition. (If the caller hangs up prior to completion of the sending of the message, interface 31 can respond by discontinuing the off-hook condition.)

A second example of the first embodiment (FIG. 1a) is illustrated as handling system 10b in FIG. 1b. This second example comprises the first example configured with additional features serving to enhance the performance. Said features comprise a plurality of call back messages 38 and a plurality of specific-time call back messages 39.

An example of plurality of call back messages 38 (FIG. 1b) will now be given. Plurality of call back messages 38 function to provide the user with a choice of call back messages to pick from during an incoming call. Out-going message sender 32 of call back circuitry 30 is configured to deliver to the caller one of call back messages: C.B. A 33, C.B. B 34 and C.B. C 35. C.B. A 33 states, “Please call back in one hour”. C.B. B 34 states, “Please call back tomorrow”. C.B. C 35 states, “Please never call back”. Message sender 32 is further configured to send a signal to interface 31 at the conclusion to sending the call back message.

During an incoming call, a user can consider their encumbrances and mood at that moment and, accordingly, deploy the most appropriate call back message by picking one of C.B. A 33, C.B. B 34 and C.B. C 35. U.I. 99 of activator 91 is configured to receive instruction from a user via the user pressing control button 43, a control signal button 44 or a control signal button 45, all three buttons shown located on telephone 27b. Each button when pressed sends a signal to U.I 99. U.I. 99 responds to the signal from button 43 by activating interface 31 and by activating sender 32 to play C.B. A 33. U.I. 99 responds to the signal from button 44 by activating interface 31 and by activating sender 32 to play C.B. 34. U.I. 99 responds to the signal from button 45 by activating interface 31 and by activating sender 32 to play C.B. 35.

An example of operation of this second example of this first embodiment, employing plurality of call back messages 38, will now be given. The embodiment operates as described above for the first example operation until the point where the user has decided to send a call back message. The user now picks message C.B. B 34 and, accordingly, presses button 44 (telephone 27b). Button 44 sends a signal to U.I. 99. U.I. 99 responds by sending a signal to interface 31 and, after a two-second delay, by sending a signal to sender 32. Interface 31 responds by going off-hook. Sender 32 responds by playing and sending C.B. B 34, “Please call back tomorrow” to the caller (via line 11 and station 120). The caller hears the message and understands to call the user back on the following day. Message sender 32 sends a signal to interface 31 at the conclusion to sending the message. Interface 31 responds by discontinuing the off-hook condition.

An example of plurality of specific-time call back messages 39 (FIG. 1b) will now be given. Messages 39 functions to provide the user with a choice of specific-time call back messages to pick from during an incoming call. Out-going message sender 32 of call back circuitry 30 is configured to deliver to the caller one of specific time messages S.T.M. 36: 1-9 & 01-09. Message 1 states, “Please call back in 10 minutes”. Message 2 states, “Please call back in 20 minutes”. Message 3 states, “Please call back in 30 minutes”. Likewise, messages 4 through 9 are configured to state 40 minutes through 90 minutes respectively. Message 01 states, “Please call back in one hour”. Message 02 states, “Please call back in two hours”. Likewise, messages 03 through 09 are configured to state 3 hours through 9 hours respectively. (Other time periods can also be provided, for example, message 001 can provide a message of, “Please call back in one day.) Message sender 32 is configured to send a signal to interface 31 at the conclusion to the sending of the specific-time call back message to terminate the off-hook condition.

During an incoming call, a user can consider their encumbrances and mood at that moment and accordingly, deploy the most appropriate call back message by picking from one of the messages: 1-9 & 01-09 of S.T.M. 36. U.I. 99 of activator 91 is configured to receive instruction from a user via a messaging button CB 46 and a keypad 47. Pressed button CB 46 instructs U.I. 99 that plurality of specific-time call back messages 39 is in operation. Pressed button CB 46 also activates keypad 47. Keypad 47 comprises keys “1” through “0” (CB 46 and keys “1” through “0” located at telephone 27b). Pressing button CB 46 activates touch-tone keys “1” through “0”. When activated, each key when pressed is configured to send a signal via line 11a to U.I. 99. U.I. 99 responds by engaging interface 31 and, after a two second delay, by engaging sender 32 to play the S.T.M. message (0-9 & 01-09) associated with the key (or keys) pressed. Pressing key-1 engages interface 31 and message-1 of S.T.M. 36. Pressing key-2 engages interface 31 and message-2 of S.T.M. 36. Pressing key-3 engages interface 31 and message-3 of S.T.M. 36, and so on through message-09. (Button CB 46 and keypad 47 can comprise common-day telephony components. Keypad 47 can be a touch-tone keypad, a touch-screen keypad, a touch-screen touch-tone keypad or other.)

An example of operation of this second example of this first embodiment, employing plurality of specific-time call back messages 39, will now be given. The embodiment operates as described above for the first example operation until the point where the user has decided to send a call back message. The user now picks message-5 of S.T.M. 36 and, to choose that message, presses button CB 46 and touch-tone key-5 (telephone 27b). Key-5 sends a signal to U.I. 99. U.I. 99 responds by sending a signal to interface 31 and, after a two-second delay, sending a signal to sender 32. Interface 31 responds by going off-hook. Sender 32 responds by playing and sending the message, “Please call back in 50 minutes” to the caller (via line 11 and station 120). The caller hears the message and understands to call the user back in 50 minutes. Message sender 32 sends a signal to interface 31 upon conclusion to sending the “50 minute” message. Interface 31 responds by discontinuing the off-hook condition.

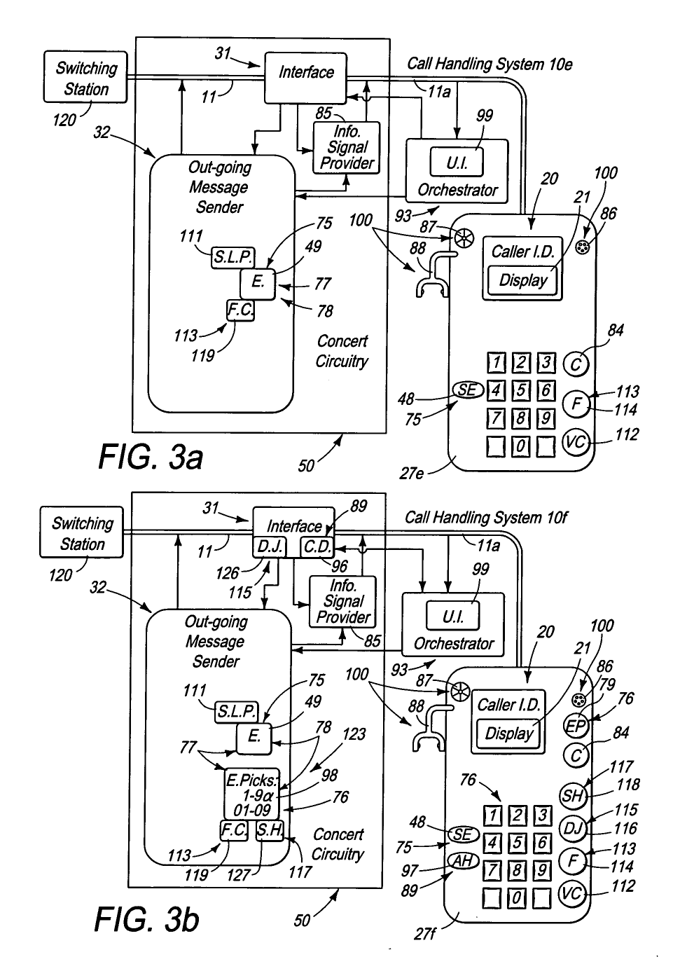

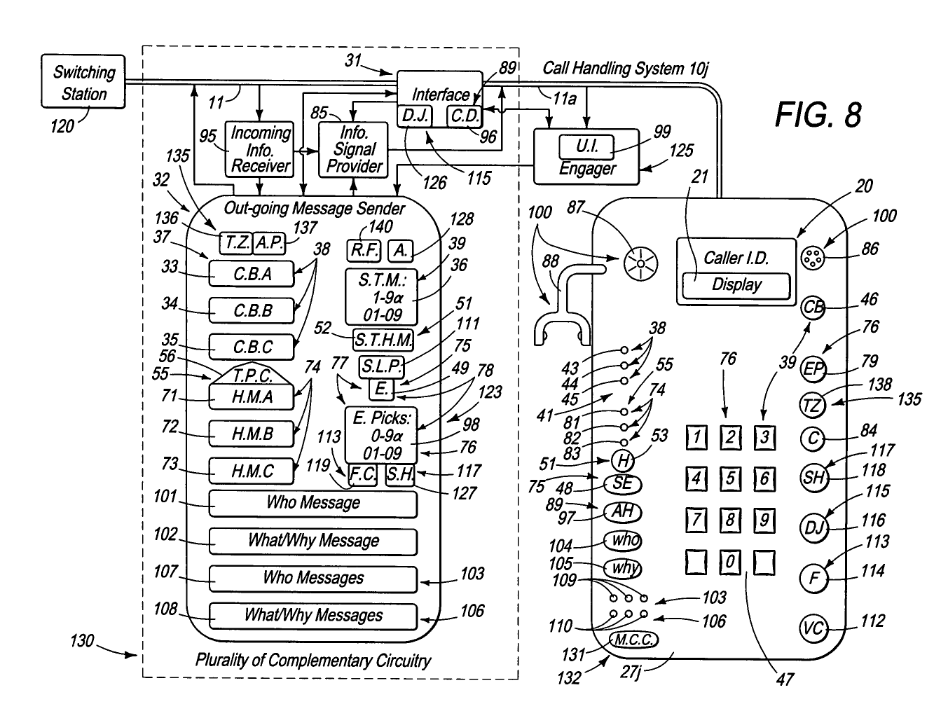

The examples of the first embodiment can be enhanced with an auto-callback 41 shown in FIGS. 1b and 8. As an example, auto-callback 41 functions to automatically send a call back message to a caller. For this example, auto-callback 41 comprises the prior described call back button 45 when pressed-for-duration. (Button 45, electrically connected to or connectable to message sender 32 and to interface 31 via line 11a and U.I. 99. Callback 41 can further comprise button 43, button 44, button CB 46 or other.) Button 45, when pressed-for-duration, sends a signal to U.I. 99 via line 11a. U.I. 99 responds by waiting for a signal from interface 31. Upon detecting a ring signal, interface 31 sends a signal to U.I. 99 (interface 31 can include call detector C.D. 96 described later and shown in FIG. 3b). In response to the signal from interface 31, U.I. 99 delays three-seconds and then signals interface 31. Interface 31 responds by going off-hook. U.I. 99 further delays an additional two-seconds and then signals message sender 32. Sender 32 responds by playing and sending call back message 35, “Please call back in one hour” to the caller. (Sender 32 then signals interface 31 and interface 31 then discontinues the off-hook condition.)

In summary, the examples of the first embodiment (FIGS. 1a and 1b) operate by: Step(1) providing caller I.D. information to a user; Step(2) receiving instruction from a user; Step(3) going off-hook in response to the instruction received; Step(4) sending a stored call back message to a caller in response to the instruction received; Step(5) discontinuing the off-hook condition.

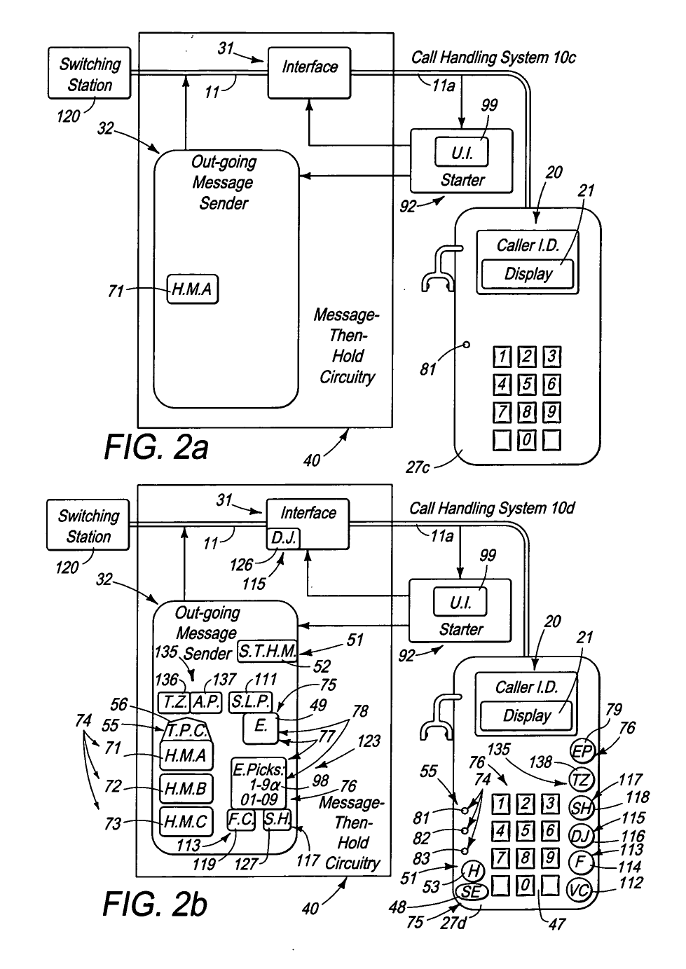

A second embodiment of telephone call handling system 10 is illustrated in FIGS. 2a and 2b. This second embodiment comprises the prior described caller I.D. circuitry 20. This embodiment also comprises message-then-hold circuitry 40 and a starter 92.

An example of message-then-hold circuitry 40 (FIGS. 2a and 2b) will now be given. Message-then-hold circuitry 40 functions to deliver, a message to a caller and then hold for a user to answer. Message-then-hold circuitry 40 comprises interface 31 (described prior) and out-going message sender 32 (described prior).

An example of starter 92 (FIGS. 2a and 2b) will now be given. Starter 92 functions to receive instruction from a user to start message-then-hold circuitry 30. Starter 92 comprises user interface (U.I.) 99 (described prior). U.I. 99 functions to receive instruction from a user. (Starter 92 can comprise a common-day telephony component.)

A first example of this second embodiment is illustrated as system 10c in FIG. 2a. Out-going message sender 32 of message-then-hold circuitry 40 is configured to store and to deliver to a caller a hold message H.M. A 71. H.M. A 71 states, “I'll be right with you”. Interface 31 is configured to maintain the off-hook condition until detecting the call being answered by the user.

U.I. 99 of starter 92 is configured to receive instruction from a user via a control button 81, button 81 electrically connected to (or connectable to) line 11 a and located at telephone 27c. When pressed, button 81 sends a control signal to U.I. 99. U.I. 99 responds by sending a signal to interface 31 and, after a two-second delay, sending a signal to sender 32. Interface 31 responds by going off-hook. Sender 32 responds by sending message H.M. A 71 to the caller.

An example of operation of this first example of this second embodiment will now be given. A user's telephone is rung by an incoming ring signal provided by station 120 via line 11 and line 11a. Delivered with the ring signal is caller I.D. information. The information appears on display 21 (located at telephone 27c). The user recognizes the phone number on the display; i.e. the user essentially knows who's calling. The user is quite busy driving his car but figures he will be comfortable to answer the call shortly. Accordingly, the user presses control button 81. Pressed button 81 sends a signal to U.I. 99 via line 11 a. U.I. 99 responds by sending a signal to interface 31 and, after a two-second delay, by sending a signal to out-going message sender 32. Interface 31 responds by going off-hook. Sender 32 responds by playing and sending H.M. A 71, “I'll be right with you” to the caller (via line 11 and switching station 120). The caller hears the message and understands the user will answer shortly. At the conclusion to the sending of the message, handling system 10c remains idle (on hold) by interface 31 maintaining the off-hook condition until the user answers the call. When the user answers, the off-hook condition of telephone 27c is detected by interface 31. Interface 31 responds by discontinuing the off-hook condition. (If the caller hangs up prior to the user answering, interface 31 can respond by discontinuing the off-hook condition.)

A second example of the second embodiment (FIG. 2a) is illustrated as telephone call handling system 10d in FIG. 2b. This second example comprises the first example configured with additional features serving to enhance the performance. Said features comprise a plurality of hold messages 74, user-selected entertainment 75, user-picked entertainment, “E. Picks” 76 and “Tiser” 135.

An example of plurality of hold messages 74 (FIG. 2b) will now be given. Plurality of hold messages 74 functions to provide the user with a choice of hold messages to pick from during an incoming call. Plurality of hold messages 74 comprises hold messages H.M. A 71, H.M. B 72 and H.M. C 73. Out-going message sender 32 of circuitry 40 is configured to deliver to a caller one of hold messages: H.M. A 71, H.M. B 72 and H.M. C 73. H.M. A 71 states, “I'll be right with you”. H.M. B 72 states, “Hold your horses, I'll be there in a jiffy”. H.M. C 73 states, “I'll be with you in a couple shakes”. Interface 31 is configured to maintain the off-hook condition until the user answers the call. When the user answers, the off-hook condition of telephone 27d is detected by interface 31. Interface 31 responds by discontinuing the off-hook condition.

During an incoming call, a user can consider their encumbrances and mood at that moment along with the identity of the caller and, accordingly, deploy the most appropriate hold message by picking one of H.M. A 71, H.M. B 72 and H.M. C 73. U.I. 99 of starter 92 is configured to receive instruction from a user via control button 81, a control button 82 and a control button 83, all three buttons shown located on telephone 27d. Each button when pressed is configured to send a signal via line 11a to U.I. 99. U.I. 99 responds by engaging interface 31 and, after a two-second delay, by engaging sender 32. U.I. 99 responds to a signal from pressed button 81 by engaging interface 31 and by engaging sender 32 to play H.M. A 71. U.I. 99 responds to a signal from pressed button 82 by engaging interface 31 and by engaging sender 32 to play H.M. B 72. U.I. 99 responds to a signal from button 83 by engaging interface 31 and by engaging sender 32 to play H.M. C 73.

An example of operation of this second example of this second embodiment, employing plurality of hold messages 74, will now be given. The embodiment operates as described above for the example of operation of this first example of this second embodiment until the point where the user has decided to place the caller on hold. The user now picks H.M. C 73 and, accordingly, presses button 83. Button 83 sends a signal to U.I. 99. U.I. 99 responds by sending a signal to interface 31 and, after a two-second delay, by sending a signal to sender 32. Interface 31 responds by going off-hook. Sender 32 responds by sending H.M. C 73, “I'll be with you in a couple shakes” to the caller. The caller hears the message and understands to wait for the user to answer. At the conclusion to the sending of the message, handling system 10d remains idle (on hold), by interface 31 maintaining the off-hook condition, until the user answers the call. When the user answers, the off-hook condition of telephone 27d is detected by interface 31. Interface 31 responds by discontinuing the off-hook condition.

An example of plurality of specific-time hold messages 51 (FIGS. 2b and 8) will now be given. Plurality of specific-time hold messages 51 functions to provide the user with a choice of specific-time hold messages to pick from during an incoming call. Plurality of specific-time hold messages 51 comprises a specific-time hold message storage S.T.H.M. 52 located at message sender 32. Message sender 32 of message-then-hold circuitry 40 is configured to deliver to the caller one of the messages stored in S.T.H.M. 52. Message 1 (of S.T.H.M. 52) states, “I'll be with you in 10 seconds”. Message 2 states, “I'll be with you in 20 seconds”. Message 3 states, “I'll be with you in 30 seconds”. Likewise, messages 4 through 9 are configured to state 40 seconds through 90 seconds respectively. Message 01 states, “I'll be with you in one minute”. Message 02 states, “I'll be with you in two minutes”. Likewise, messages 03 through 09 are configured to state 3 minutes through 9 minutes respectively. (Other time periods can also be provided.)

During an incoming call, a user can consider their encumbrances and mood at that moment and accordingly, deploy the most appropriate specific-time hold message stored in S.T.H.M. 52. U.I. 99 of activator 91 is configured to receive instruction from a user via a hold button H 53 and keypad 47 (both shown located at telephone 27d, keypad 47 described prior). Pressed button H 53 instructs U.I. 99 that plurality of specific-time hold messages 51 is in operation. Pressed button H 53 also activates keys “1” through “0” of keypad 47. When activated, each key when pressed is configured to send a signal via line 11a to U.I. 99. U.I. 99 responds by engaging interface 31 and, after a two second delay, by engaging sender 32 to play the message stored in S.T.H.M. 52 associated with the key (or keys) pressed. Pressing key-1 engages interface 31 and a message-1 of S.T.H.M. 52. Pressing key-2 engages interface 31 and a message-2 of S.T.H.M. 52. Pressing key-3 engages interface 31 and a message-3 of S.T.H.M. 52, and so on through a message-09. (Button H 53 can comprise a common-day telephony component.)

An example of operation of this second example of this second embodiment, employing plurality of hold messages 51, will now be given. The embodiment operates as described above for the example of operation of this first example of this second embodiment until the point where the user has decided to place the caller on hold. The user figures he'll be available in approximately 40 seconds. Accordingly, the user presses button H followed by key-4. Pressed button H 53 instructs U.I. 99 that plurality of specific-time hold messages 51 is in operation. Pressed button H 53 also activates keys “1” through “0” of keypad 47. Subsequently pressed key-4 sends a signal to U.I. 99. U.I. 99 responds by sending a signal to interface 31 and, after a two-second delay, sending a signal to sender 32. Interface 31 responds by going off-hook. Sender 32 responds by playing and sending the message-4 stored in S.T.H.M. 52, “I'll be with you in 40 seconds” to the caller (via line 11 and station 120). The caller hears the message and anticipates that the user will answer in some 40 seconds. At the conclusion to the sending of the hold message, handling system 10d remains idle (on hold), by interface 31 maintaining the off-hook condition, until the user answers the call. When the user answers, the off-hook condition of telephone 27d is detected by interface 31. Interface 31 responds by discontinuing the off-hook condition.

An example of user-selected entertainment 75 (FIG. 2b) will now be given. Entertainment 75 functions to enable a user to select entertainment prior to an incoming call, for play during the incoming call. Entertainment 75 comprises a stored entertainment E. 49 located at out-going message sender 32. Sender 32 of message-then-hold circuitry 40 is configured to store and to deliver to a caller entertainment E. 49.

E. 49 can comprise music 77 and/or an interesting sound 78 (or other interesting content). The user downloads music 77 and/or sound 78 into sender 32 via system 10d. (Music 77 can be downloaded from a music web sight or service provider web site or downloaded from a music player or some other form of music library, or other. Interesting sound 78 can be download from wherever said sounds can be found such as on the internet or a music player, or other. Alternately, thousands of songs (music) 77 and/or sounds 78 can be provided pre-loaded in phone 27d by the manufacturer of phone 27d to be selected/loaded by the user to be E. 49. The downloading process can be configured such as today's practice of downloading a ring-tone into a phone. Accordingly, the downloading process has not been described in detail.)

U.I. 99 (of starter 92) is configured to receive instruction from a user via a selected entertainment button SE 48, button 48 electrically connected to (or connectable to) line 11a and located at telephone 27d. SE 48 is configured to send a control signal via line 11a to U.I. 99. U.I. 99 responds by signaling sender 32. Provided that one of plurality of hold messages 74: button 81, button 82 or button 83 has been pressed prior during the incoming call, sender 32 responds by disabling the sending of E. 49. In other words, if SE 48 is not pressed, E. 49 will be played to the caller upon completion of whichever of the hold message the user has chosen: H.M. A 71, H.M. B 72 or H.M. C 73.

An example of operation of this second example of this second embodiment, employing user-selected entertainment 75, will now be given. The embodiment operates as described above for the example of operation of the second example of the second embodiment (employing plurality of hold messages 74) until the point where the user has pressed button 83. Sender 32 has responded by sending H.M. C 73, “I'll be with you in a couple shakes” to the caller. (Interface 31 has gone off-hook.) The user now presses the SE 48 button. Pressed button 48 sends a signal to U.I. 99. U.I. 99 responds by sending a signal to sender 32. Sender 32 responds by not playing the music stored in E. 49. No entertainment is played to the caller. (As a converse example, the user does not press the SE 48 button. Consequently, at the conclusion of the hold message, E. 49 is played to the caller.) Handling system 10d remains idle (on hold) by interface 31 maintaining the off-hook condition, until the user answers the call. When the user answers, the off-hook condition of telephone 27d is detected by interface 31. Interface 31 responds by discontinuing the off-hook condition.

Alternately, user selected entertainment 75 can be configured to function without plurality of hold messages 74 (or without a solitary hold message depicted prior as H.M. A 71, or without plurality of specific-time hold messages 51). For example, the user has decided to put the caller on hold. The user does not press hold message button 83 but, instead, twice presses selected entertainment button SE 48. Sender 32 responds by playing and sending E. 49. Consequently, the caller is only played E. 49, i.e. no hold message. In this case, E. 49 serves as both the hold message and the entertainment. (Also, entertainment 75 can be configured to function without plurality of hold messages 74 and, instead, to function with a solitary hold message, for example, the solitary message H.M. A 71 described in the first example of this second embodiment.)

An example of user picked entertainment E. Picks 76 (FIG. 2b) will now be given. E. Picks 76 functions to provide the user with a choice of entertainment to pick from during an incoming call. E. Picks 76 comprises an entertainment pick storage 98 shown located at sender 32, a button EP 79 located at telephone 27d and a keypad 47 located at telephone 27d. Out-going message sender 32 is configured to deliver to a caller one of a plurality of entertainment choices stored in pick storage 98 shown as E. Picks: 1-9 & 01-09. Each of picks 1 through 9 comprises a song (music) 77. Each of picks 01 through 09 comprises an interesting sound 78. (For E. 49, the user can download one entertainment to be enabled or not by the user during an incoming call, when enabled played and sent by sender 32. For E. Picks 76, the user can download a plurality of entertainment from which one can be picked by the user during an incoming call, the picked entertainment to then be played and sent by sender 32. Accordingly, the user can download music 77 and/or sound 78, or other, into pick storage 98 of E. Picks 76 in the manner as described prior for downloading entertainment into user-selected entertainment E. 49.)

During an incoming call, a user can consider their mood at that moment along with the identity of the caller and, accordingly, deploy the most appropriate entertainment by picking one of storage 98 E. Picks: 1-9 & 01-09. U.I. 99 of starter 92 is configured to receive instruction from a user via button EP 79 and keypad 47. Pressed button EP 79 instructs U.I. 99 that E. Picks 76 is in operation. Pressed button EP 79 also activates keypad 47. (Keypad 47, comprising keys “1” through “0” and shown located at telephone 27d, has been described prior when employed in call back messages 39.) When activated, each key when pressed is configured to send a signal via line 11a to U.I. 99. U.I. 99 responds by engaging interface 31 to go off-hook (if not already off-hook) and, after a two-second delay, by engaging sender 32 to play the stored E. Picks: 0-9 & 01-09 associated with the key pressed. Pressing key-1 engages pick-1. Pressing key-2 engages pick-2. Pressing key-3 engages pick-3, and so on through pick-09.

An example of operation of this second example of this second embodiment, employing E. Picks 76, will now be given. The embodiment operates as described above for the example of operation of the second example of this second embodiment (employing plurality of hold messages 74) until the point where the user has pressed button 83. Sender 32 has responded by sending H.M. C 73, “I'll be with you in a couple shakes” to the caller. (Interface 31 has gone off-hook.) The user now presses the EP 79 button and presses key-3 of keypad 47. Key-3 responds by sending a signal to U.I. 99. U.I. 99 responds by sending a signal to sender 32. Sender 32 responds by playing the music stored as pick-3 of pick storage 98. The caller then hears the music and may enjoy. Sender 32 continues playing the music as handling system 10d remains idle (on hold), by interface 31 maintaining the off-hook condition, until the user answers the call. When the user answers, the off-hook condition of telephone 27d is detected by interface 31. Interface 31 responds by discontinuing the off-hook condition.

Alternately, E. Picks 76 can be configured to operate without plurality of hold messages 74. For example, when the user has decided to place the caller on hold, the user presses the EP 79 button followed by a key on keypad 47. The key sends a signal to U.I. 99. U.I. 99 responds by sending a signal to interface 31 and, after a two-second delay by sending a signal to sender 32. Interface 31 responds by going off-hook. Sender 32 responds by sending the appropriate music to the caller. Consequently, the caller will be played only whatever E. Picks: 0-9 & 01-09 pick from storage 98 that the user has chosen. In other words, the user's pick from E. Picks: 0-9 & 01-09 will serve as both the hold message and the entertainment. (Also, E. Picks 76 can be configured to function without plurality of hold messages 74 and, instead, to function with a solitary hold message, for example, H.M. A 71 described prior in the first example of this second embodiment. Further, E. Picks 76 can be configured to function such that the user provides a live hold message in place of, or in addition to, the pre-recorded/stored hold message. Also, E. Picks 76 can comprise entertainment picks displayed and picked from a graphical user interface, graphical user interface described later.)

An example of Tiser 135 (FIG. 2b) will now be given. Tiser 135 functions to provide the user with an advertiser hold message to selectively engage during an incoming call. Tiser 135 comprises a stored advertisement T.Z. 136 located at out-going message sender 32. Sender 32 of message-then-hold circuitry 40 is configured to store and to deliver to a caller T.Z. 136.

Advertisers can pay to have stored advertisement T.Z. 136 played by the called party. For each minute of play T.Z. 136 gets, advertisers can pay the service provider a fee, and the service provider can in turn reduce the user's monthly bill by a percentage of the fee. For example, Kmart agrees to pay the service provider $0.20 (i.e., 20 cents) each time an advertisement is played promoting their latest specials, and the service provider agrees to reduce the user's monthly service bill by $0.10 each time the user allows the Kmart advertisement to be played. Tracking (and thus accounting) of the number of times an advertisement is played, and by whom (i.e., the subscribers) can be tracked by a service-provider computer.

U.I. 99 (of starter 92) is configured to receive instruction from a user via a Tiser button TZ 138, button 138 electrically connected to (or connectable to) line 11a and located at telephone 27d. TZ 138 is configured to send a control signal via line 11a to U.I. 99. U.I. 99 responds by signaling interface 31 to go off-hook (if not already off-hook) and by signaling sender 32. Provided that one of plurality of hold messages 74: button 81, button 82 or button 83 has been pressed prior during the incoming call, sender 32 responds by playing and sending T.Z. 136 to the caller.

An example of operation of this second example of this second embodiment, employing Tiser 135, will now be given. The embodiment operates as described above for the example of operation of the second example of the second embodiment (employing plurality of hold messages 74) until the point where the user has pressed button 83. Sender 32 has responded by sending H.M. C 73, “I'll be with you in a couple shakes” to the caller. (Interface 31 has gone off-hook.) The user is having trouble paying his cell phone bill and the person who the caller I.D. suggests is calling owes him money, so the user now presses button TZ 138. Pressed button 138 sends a signal to U.I. 99. U.I. 99 responds by sending a signal to sender 32. Sender 32 responds by playing the advertisement stored in T.Z. 136. When the user answers, the off-hook condition of telephone 27d is detected by interface 31. Interface 31 responds by discontinuing the off-hook condition.

Alternately, Tiser 135 can be configured to function without plurality of hold messages 74. For example, the user has decided to put the caller on hold. The user does not press button 83 but, instead, twice presses button TZ 138. Sender 32 responds by playing and sending T.Z. 136. (Also, Tiser 135 can be configured to function without plurality of hold messages 74 and, instead, to function with a solitary hold message such as the message employed in the first example of this second embodiment. Further, Tiser 135 can be configured to function such that the user provides a live hold message in the place of, or in addition to, the pre-recorded/stored hold message.)

Tiser 135 can be enhanced with an advertiser picks A.P. 137 shown located at message sender 32 in FIGS. 2b and 8. As an example, A.P. 137 functions to provide the user with a choice of advertisers to pick from during an incoming call. As an example of operation of A.P. 137, button 138 is pressed-for-duration. Pressed-for-duration button 138 instructs U.I. 99 that Tiser 135 is in operation and activates keys 0 through 9. Each pressed key 0 through 9 designates an advertisement stored in A.P. 137 to be played and sent by sender 32. Pressed key-1 plays and sends a McDonalds ad. Pressed key-2 plays and sends an IHOP ad and so forth. (A.P. 137 can also employ keys 01 through 09, 001 through 009, etc. A.P. 137 can comprise advertiser picks displayed and picked from a graphical user interface, graphical user interface described later.)

Message-then-hold circuitry 40 can comprise a content message-then-hold 55 shown in FIGS. 2b and 8. As an example of operation, responding to caller I.D. information provided with an incoming call, a user presses-for-duration control button 81 (for example). If button 81 had been pressed, but not for duration, hold message H.M. A 71, “I'll be right with you” would have been sent to the caller. However, with hold button 81 pressed-for-duration, U.I. 99 instructs message sender 32 to add message T.P.C. 56 “to provide content” to the message. In other words, sender 32 responds to pressed-for-duration button 81 by sending to the caller, “I'll be right with you to provide content”. Subsequent to sending the message, system 10 then remains idle until the content is delivered and the user answers the call, or until the content is delivered and the caller hangs up, or until the content is delivered and the system hangs up, or other. During the idle (on hold) period, the user can find, select and/or copy and send content (or a content's address or other) to the caller. The content can be content stored in the user's phone, stored at the service provider or stored on the internet, or other. Also, the hold message can be any of the described prior hold messages, or other, including any one of plurality of hold messages 74, any one of specific-time hold messages 51, or other. Content sent to the caller can be content to be displayed on a display on the caller's telephone, content to be heard by the caller, content to be stored in the caller's phone or other.

In summary, the examples of the second embodiment (FIGS. 2a and 2b) operate by: Step(1) providing caller I.D. information to a user; Step(2) receiving instruction from a user; Step(3) going off-hook in response to the instruction received; Step(4) sending a stored hold message to a caller in response to the instruction received; Step(5) maintaining the off-hook condition until a user answers the incoming call (or the caller hangs up).

A third embodiment of telephone call handling system 10 is illustrated in FIGS. 3a and 3b. This third embodiment comprises caller I.D. circuitry 20 (described prior). This embodiment also comprises concert circuitry 50 and an orchestrator 93.

An example of concert circuitry 50 (FIGS. 3a and 3b) will now be given. Concert circuitry 50 functions to deliver entertainment simultaneously to a caller and to a user. Concert circuitry 50 comprises interface 31 (described prior), out-going message sender 32 (described prior) and an information signal provider 85.

An example of information signal provider 85 (FIGS. 3a and 3b) will now be given. Provider 85 functions to provide at least one signal to operate an information deliverer 100 to deliver information to a user. Provider 85 is electrically connected to (or connectable to) information deliverer 100 via line 11a. Deliverer 100 comprises one or more of: a telephone receiver 86, a telephone loudspeaker 87 or an earphone set 88 (telephones 27e and 270. Receiver 86, loudspeaker 87 and earphone set 88 are electrically connected to (or connectable to) line 11a. (Signal provider 85 and deliverer 100 can comprise common-day telephony components.)

An example of orchestrator 93 (FIGS. 3a and 3b) will now be given. Orchestrator 93 functions to receive instruction from a user to orchestrate concert circuitry 50. Orchestrator 93 comprises user interface (U.I.) 99 (described prior). U.I. 99 functions to receive instruction from a user. (Orchestrator 93 can comprise a common-day telephony component.)

A first example of this third embodiment is illustrated as system 10e in FIG. 3a. Out-going message sender 32 of concert circuitry 50 is configured to provide entertainment information E. 49 of user selected entertainment 75 to a caller. Sender 32 is further configured to send E. 49 to information signal provider 85. Information signal provider 85 is configured to receive entertainment information E. 49 from message sender 32 and to send entertainment information E. 49 to deliverer 100 via line 11a. (E. 49 and entertainment 75 described prior. E. 49 can comprise music 77 and/or an interesting sound 78 shown in FIGS. 2b, 3a, 3b and 8, described prior.) E. 49 can comprise a song-last-played S.L.P. 111 (S.L.P. 111 shown in FIGS. 2b, 3a, 3b and 8.) As an example, when handling system 10 is being employed as a music player (or other) and E. 49 (or pick storage 98 or other) is being played, message sender 32 is configured to store in S.L.P. 111 the entertainment being played. When E.49 is subsequently distinguished for play, sender 32 plays and sends S.L.P. 111.

U.I. 99 of orchestrator 93 is configured to receive instruction from a user via a concert button C 84 in conjunction with select entertainment button SE 48, buttons C 84 and SE 48 electrically connected to (or connectable to) line 11a and located at telephone 27e. (Button SE 48 described prior.) U.I. 99 responds to a pressed C 84 in conjunction with a pressed SE 48 by sending a signal to interface 31 and, after a two second delay, by sending a signal to sender 32. Interface 31 responds by going off-hook. Sender 32 responds by playing and sending E. 49 to the caller. Sender 32 further responds by sending the played music to signal provider 85.

An example of operation of this first example of this third embodiment will now be given. A user's telephone is rung by an incoming ring signal provided by station 120 via line 11 and line 11a. Delivered with the ring signal is caller I.D. information. The information appears on display 21 (telephone 27e). The user recognizes the phone number on the display; i.e. the user essentially knows that his good friend Albert is calling. The user decides he'd like to share a song from his new Pink Lady album with Albert, the user having prior to the incoming call loaded the song into E. 49 of sender 32. Accordingly, the user presses concert button C 84. The user then presses button SE 48. When pressed, buttons C 84 and SE 48 each send a control signal to U.I. 99. U.I. 99 responds to the succession of signals by sending a signal to interface 31 and, after a two-second delay, by sending a signal to sender 32. Interface 31 responds by going off-hook. Sender 32 responds by playing the E. 49 song and sending the played music to the caller via line 11 and switching station 120. Sender 32 further responds by sending the played music to signal provider 85. Provider 85 responds by sending the played music to earphone 88 (or loudspeaker 87 or both) of deliverer 100 and, thus, to the user (via line 11a). Both caller and user then enjoy the music.

Subsequently, the user decides he wants to speak with the caller while they both enjoy the music. The user answers his phone. Interface 31 responds to the off-hook phone by sending a signal to provider 85 and by communicably connecting caller and user. Provider 85 responds by discontinuing the music to earphone 88 and by instead sending the played music to telephone receiver 86. Caller and user now converse while the music plays. At conclusion to the concert/conversation, the user hangs up his phone. Interface 31 responds to the on-hook condition at telephone 27e by communicably disconnecting caller and user and by sending a signal to sender 32. Sender 32 responds by discontinuing the playing and sending of E. 49. (If the caller hangs up prior to the user hang-up, interface 31 can respond to the caller hang-up by discontinuing the off-hook condition.)

A second example of this third embodiment is illustrated as system 10f in FIG. 3b. This second example comprises the first example configured with additional features serving to enhance the performance. Said features comprise user-picked entertainment E. Picks 76 and an auto-hold 89. (E. Picks 76 described prior.)

A first example of this second example of this third embodiment, employing E. Picks 76, will now be given. Out-going message sender 32 is configured to deliver to a caller one of a plurality of entertainment choices stored in pick storage 98 shown as E. Picks: 1-9 & 01-09. Sender 32 is further configured to deliver to signal provider 85 one of a plurality of entertainment choices stored in pick storage 98 E. Picks: 1-9 & 01-09. (Storage 98 can comprise music 77 and/or an interesting sound 78, or other, described prior.)

Information signal provider 85 is configured to receive one of pick storage 98 E. Picks: 1-9 & 01-09 from message sender 32 and to send the one of pick storage 98 E. Picks: 1-9 & 01-09 to deliverer 100 via line 11a.

U.I. 99 of orchestrator 93 is configured to receive instruction from a user via concert button C 84, E. Picks button EP 79 and one key, or two keys (or more) pressed in succession, from keypad 47, keypad 47 comprising keys 1 through 0. Button C 84, button EP 79 and keys 1 through 0 each are electrically connected to (or connectable to) line 11a and located at telephone 27f. U.I. 99 is also configured to send a signal to sender 32 as well as to send a signal to interface 31. (EP 79 and Keypad 47 described prior.)

An example of operation of this second example of this third embodiment, employing E. Picks 76, will now be given. A user's telephone is rung by an incoming ring signal provided by station 120 via line 11 and line 11a. Delivered with the ring signal is caller I.D. information. The information appears on display 21 (telephone 27f). The user recognizes the phone number on the display; i.e. the user essentially knows that his brother Bobby is calling.

The user can consider their mood at that moment along with the identity of the caller and deploy the most appropriate entertainment by picking one of pick storage 98 E. Picks: 1-9 & 01-09. The user decides he'd like to share “sounds of nature” with Bobby, the user having prior to the incoming call loaded “sounds of nature” into E. Pick-04 of pick storage 98. Accordingly, the user presses concert button C 84. The user then presses button EP 79. The user then presses key-0 and key-4. Pressed button EP 79 activates keypad 47. Button C 84 followed by key-0 and key-4 each sends a control signal to U.I. 99. U.I. 99 responds to the succession of signals by sending a signal to interface 31 and, after a two-second delay, sending a signal to sender 32. Interface 31 responds by going off-hook. Sender 32 responds by playing E. Pick-04 from pick storage 98 and sending the played sound to the caller via line 11 and switching station 120. Sender 32 further responds by sending the played sound to signal provider 85. Provider 85 responds by sending the played sound to loudspeaker 87 of deliverer 100 and, thus, to the user (via line 11a). Both caller and user then enjoy sounds of nature.

Subsequently, the user decides he wants to speak with the caller while they both enjoy the sound. The user answers his phone. Interface 31 responds to the off-hook phone by sending a signal to provider 85 and by communicably connecting caller and user. Provider 85 responds by discontinuing the sound to loudspeaker 87 and by instead sending the played sound to telephone receiver 86. Caller and user now converse while the sound plays. At conclusion to the concert/conversation, the user hangs up his phone. Interface 31 responds to the on-hook condition by communicably disconnecting caller and user and by sending a signal to sender 32. Sender 32 responds by discontinuing the playing and sending of E. Pick-04.

A second example of operation of this second example of this third embodiment, employing E. Picks 76, will now be given. A user desires to employ handling system 10 as a music player. The user decides he wants to hear the music stored in E. Pick-6 of pick storage 98. To do so (with no incoming call present), the user presses button C 84 twice, then presses button EP 79 and then presses key-6. Pressed button EP 79 activates keypad 47. Each of the two presses of button C 84 sends a signal to U.I. 99 followed by a signal from the pressed key-6 also sent to U.I. 99. U.I. 99 responds to the succession of signals by sending a signal to sender 32. (No signal sent to interface 31.) Sender 32 responds by playing E. Pick-6 from pick storage 98 and sending the played music to signal provider 85. Provider 85 responds by sending the played music to earphone 88 (or loudspeaker 87 or both) of deliverer 100 and, thus, to the user (via line 11a).

Sometime later, the user's telephone now is rung by an incoming ring signal from station 120 via line 11 and line 11a. With the ring signal is caller I.D. information displayed on display 21 (telephone 27f.). The user does not recognize the phone number on the display. However, the user is in a social mood so he decides to share the music he is enjoying with this caller. To do so, the user again presses the concert button C 84. Pressed button C 84 sends a control signal to U.I. 99. U.I. 99 responds by sending a signal to interface 31 and, after a one-second delay, by sending a signal to message sender 32. Interface 31 responds by going off-hook. Sender 32 responds by sending the playing music (E. Pick-6) to the caller via line 11 and switching station 120. User and caller may enjoy the music. (Alternately, the user can send a music/sound to the caller other than the music/sound the user is listening to. As an example of operation, responsive to the caller I.D. information, the user presses-for-duration button C 84 then presses EP 79 and key-4. Consequently, sender 32 plays and sends E. Pick-4 to the caller while the user may continue listening to E. Pick-6. The user may then discontinue the music (or sound) being sent to caller and user and answer the call, or other. As another example of operation, responsive to the caller I.D. information, the user presses for duration button SE 48. Consequently, sender 32 plays and sends E. 49 to the caller while the user may continue listening to E. Pick-6.)

Subsequently, the user decides he wants to speak with the caller while they both enjoy the music. The user answers his phone. Interface 31 responds to the off-hook phone by sending a signal to provider 85 and by communicably connecting caller and user. Provider 85 responds by discontinuing the music to earphone 88 and by instead sending the played music to telephone receiver 86. Caller and user converse while the music plays. When the user hangs up his phone, interface 31 responds to the on-hook condition by communicably disconnecting caller and user and by sending a signal to sender 32. Sender 32 responds by discontinuing the playing and sending of E. Pick-6. Alternately, the user can decide to discontinue the concert prior to (or while) speaking with the caller. In that case, for example, the user twice presses the concert button C 84. The two signals from C 84 are received by U.I. 99. U.I. 99 responds by sending a signal to sender 32. Sender 32 responds by discontinuing the playing and sending of E. Pick-6. The user then answers his phone and talks to the caller. (Also, E. Picks 76 can comprise entertainment picks displayed and picked from a graphical user interface, said user interface described later.)

A second example of this second example of this third embodiment, employing auto-hold 89, will now be given. This second example comprises the first example of this second example of this third embodiment further comprising auto-hold 89. Auto-hold 89 functions to automatically place a caller on hold. Auto-hold 89 comprises an auto-hold button AH 97 located at telephone 27f and a call detector C.D. 96 located at interface 31. C.D. 96 functions to detect the presence of an incoming ring signal on line 11. When pressed, button AH 97 sends a signal to U.I. 99 via line 11a. U.I. 99 responds by waiting for a signal from C.D. 96. Upon detecting a ring signal, C.D. 96 responds by sending a signal to U.I. 99. If button AH 97 has been pressed, in response to the signal from C.D. 96, U.I. 99 delays three-seconds and then signals interface 31. Interface 31 responds by going off-hook. (Detector C.D. 96 can comprise a common-day telephony component.)

An example of operation of this second example of this second example of this third embodiment, employing auto-hold 89, will now be given. The user first presses the auto-hold AH 97 button. The user desires to employ E. Picks 76 as a music player and, to do so, follows the procedure described above in the second example of operation of this second example of this third embodiment. Sender 32 responds by playing the E. Pick picked by the user and by sending the played music to signal provider 85. Provider 85 responds by sending the played music to earphone 88 of deliverer 100 and, thus, to the user (via line 11a).

Subsequently, the user's telephone receives an incoming ring signal from station 120 via line 11 and line 11a. With the ring signal is caller I.D. information displayed on display 21 (telephone 27f.). From the information, the user pretty much knows that Mark is calling. The user decides that rather than immediately answer the call, he'd prefer to take his time answering and, also, he wants Mark to hear the music that the user is listening to. Having previously activated auto-hold 89, the user simply waits. Call detector C.D. 96, upon detecting the presence of the incoming ring signal on line 11, responds by sending a signal to U.I. 99. U.I. 99 responds by delaying three seconds and then sending a signal to interface 31. Interface 31 responds by going off-hook. U.I. 99 also sends a signal to sender 32 (also after the three-second delay). Sender 32 responds by sending the music being played to the user to the caller via line 11 and station 120. Now, user and caller may simultaneously enjoy the music. (The user then can answer the call while the music continues to be played or can answer after the music has concluded. Alternately, the user can stop the playing music and then answer or can answer and then stop the playing, said answering and stopping as described above in the second example of operation of this second example of this third embodiment. Also, message-then-hold circuitry 40 can comprise auto-hold 89. The user first presses the auto-hold AH 97 button. The user then presses a hold message button (or buttons, including SE 48 and EP 79). Subsequently, auto-hold 89 detects an incoming call and signals interface 31 and sender 32. In response, interface 31 goes off-hook and sender 32 sends a hold message to the caller, including or not hold entertainment/content.)

User selected entertainment 75 and E. Picks 76 can be enhanced with a volume control VC 112 shown located at telephone 27 in FIGS. 2b, 3a, 3b and 8. As an example, Control VC 112 functions to enable a user to control the volume of message E. 49 and/or pick storage 98 E. Picks: 1-9 & 01-09. VC 112 is electrically connected to (or connectable to) message sender 32 via line 11a and U.I. 99. (V.C. 112 can be further configured to control the volume of any/all messages/information sent from sender 32 to the caller.)

Concert circuitry 50 can be enhanced with a fader 113 shown in FIGS. 3a, 3b and 8. As an example, fader 113 functions to fade out the entertainment. Fader 113 comprises fader button F 114 and fader circuitry (F.C.) 119. Button 114 is electrically connected to (or connectable to) message sender 32 and to interface 31 via line 11 a and U.I. 99. Pressed button 114 turns on fader 113. Pressed again button 114 turns off fader 113. Interface 31 detects the user's phone off-hook and signals F.C. 119. When fader 113 is on, F.C. 119 responds to the signal by lowering the volume of the playing entertainment over a set or user adjustable period of time.

Concert circuitry 50, and also message-then-hold circuitry 40, can comprise a Disk Jockey 115, shown in FIGS. 2b, 3b and 8. As an example, Disc Jockey 115 functions to enable the user to announce entertainment (or advertisement). Jockey 115 comprises button DJ 116 and circuitry D.J. 126. Button 116 is electrically connected to (or connectable to) D.J. 126 located at interface 31 via line 11a and U.I. 99. As an example of operation, pressed button DJ 116 instructs D.J. 126 to connect the microphone of the user's telephone to line 11 such that the caller can hear the user's but the user can't hear the caller's voice. (Alternately, D.J. 126 can also allow the user to hear the caller's voice and, also, can be configured to provided a pre-recorded message via sender 32 to introduce the entertainment in place of, or in addition to, the live user introduction.)

Concert circuitry 50, and also message-then-hold circuitry 40, can comprise a shuffler 117, shown in FIGS. 2b, 3b and 8. As an example, shuffler 115 functions to choose entertainment (or advertisement). Shuffler 117 comprises button SH 118 and circuitry S.H. 127. Button 118 is electrically connected to (or connectable to) S.H. 127 located at sender 32 via line 11 a and U.I. 99. Pressed SH 118 turns on shuffler 117. Pressed again SH 118 turns off shuffler 117. As an example of operation, with shuffler 117 on, the user presses concert button C 84. S.H. 127 responds by randomly choosing one of storage 98 E. Picks: 1-9 & 01-09 (or other) and plays and sends the entertainment to caller and user. As another example, with shuffler 117 on, the user presses one of hold messages 74 buttons 81, 82 or 83 and then presses EP 79. The respective hold message is played. S.H. 127 then chooses and plays to the caller one of storage 98 E. Picks: 1-9 & 01-09.

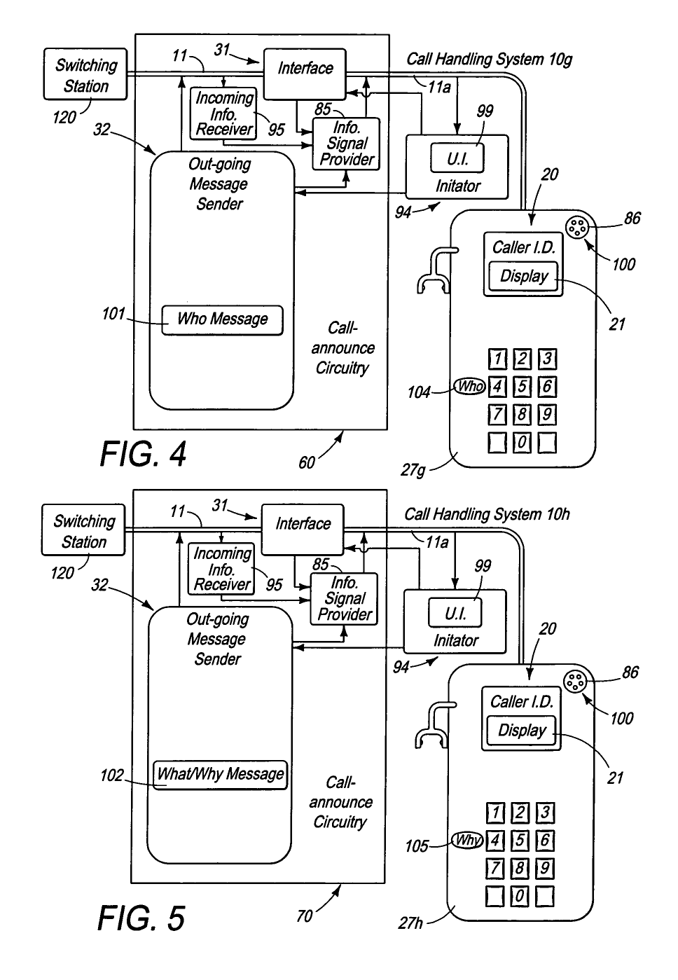

Concert circuitry 50, and also message-then-hold circuitry 40, can comprise a caller picked entertainment 123, shown in FIGS. 2b, 3b and 8. As an example, picked entertainment 123 functions to enable the caller to pick entertainment (or advertisement). An example of operation of the second example of the second embodiment (message-then-hold circuitry 40, employing E. Picks 76) employing caller picked entertainment 123, will now be given. The embodiment operates as described for the example of operation of the second example of the second embodiment (employing plurality of hold messages 74) until the point where the user has pressed button 83. Sender 32 has responded by sending H.M. C 73, “I'll be with you in a couple shakes” to the caller. (Interface 31 has gone off-hook.) The user now presses-for-duration button EP 79. Pressed-for-duration button EP 79 instructs U.I. 99 to operate caller picked entertainment 123. U.I. 99 responds by sending a signal to message sender 32. Sender 32 responds by playing and sending to the caller, “To hear rap press (or say) one, to hear funk press two, to hear country press three”, and so on. The caller presses one and the pick is received at information receiver 95. (Receiver 95 is described later and shown in FIGS. 4, 5, 6 and 8. For this example, receiver 95 is configured to receive DTMF signals.) Receiver 95 responds by sending a signal to sender 32 (FIG. 8). Sender 32 responds by playing and sending pick-1 of storage 98 to the caller. (Entertainment 123 can also employ E. Picks 76, or other, when entertainment 123 is employed with circuitry 50.)

In summary, the examples of the third embodiment (FIGS. 3a and 3b) operate by: Step(1) providing caller I.D. information to a user; Step(2) receiving instruction from a user; Step(3) going off-hook in response to the instruction received; Step(4) delivering entertainment simultaneously to a caller and to a user in response to the instruction received.

A fourth embodiment of telephone call handling system 10 is illustrated in FIG. 4. This fourth embodiment comprises caller I.D. circuitry 20 (described prior). This embodiment also comprises call-announce circuitry configured to attain who-information 60, and an initiator 94.

An example of call-announce circuitry configured to attain who-information 60 (FIG. 4) will now be given. Call-announce circuitry 60 functions to answer a telephone call and to attain call-announce information input by a caller and to provide at least one signal to deliver at least some of the attained information to a user. Call-announce circuitry 60 comprises interface 31 (described prior), out-going message sender 32 (described prior), information signal provider 85 (described prior) and an incoming information receiver 95.

An example of incoming information receiver 95 (FIG. 4) will now be given. Information receiver 95 functions to receive information input by a caller. Receiver 95 is electrically connected to (or connectable to) line 11 and therefrom receives spoken information from the caller.

An example of initiator 94 (FIG. 4) will now be given. Initiator 94 functions to receive instruction from a user to initiate call-announce circuitry configured to attain who-information 60. (Additionally, initiator 94 can function to receive instruction from a user to initiate call-announce circuitry configured to attain what/why-information 70, circuitry 70 described later.) Initiator 94 comprises user interface (U.I.) 99. U.I. 99 functions to receive instruction from a user. (Incoming information receiver 95 and initiator 94 can comprise common-day telephony components.)

An example of this fourth embodiment is illustrated as system 10g in FIG. 4. Out-going message sender 32 of call-announce circuitry 60 is configured to store and to send to a caller a who-message 101. Who-message 101 states (for example), “Whom may I say is calling?”

U.I. 99 of initiator 94 is configured to receive instruction from a user via a control button Who 104, Who 104 electrically connected to (or connectable to) line 11a and located at telephone 27g. When pressed, Who 104 sends a control signal to U.I. 99. U.I. 99 responds by sending a signal to interface 31 and, after a two-second delay, by sending a signal to sender 32. Interface 31 responds by going off-hook. Sender 32 responds by sending who-message 101 to the caller.

An example of operation of this example of this fourth embodiment will now be given. A user's telephone is rung by an incoming ring signal from station 120 via line 11 and line 11a. Delivered with the ring signal is caller I.D. information. The information appears on display 21 (telephone 27g). Display 21 shows the caller as “Private Caller”. Accordingly, the user does not know who's calling. The user presses button Who 104. Who 104 sends a control signal to U.I. 99. U.I. 99 responds by sending a signal to interface 31 and, after a two-second delay, by sending a signal to sender 32. Interface 31 responds by going off-hook. Sender 32 responds by sending who-message 101, “Whom may I say is calling?” to the caller. The caller then states his name, “Paul Bunyun”. Information receiver 95 receives the stated “Paul Bunyun” information. Receiver 95 forwards the information to information signal provider 85. Provider 85 forwards the information to telephone receiver 86 (or loudspeaker 87, or other) of information deliverer 100 via line 11a. Receiver 86 emits “Paul Bunyun”. The user hears the response and recognizes the caller. The user then answers the call (or not). (If not, after a given amount of delay, the caller can be forwarded to an answering machine or voice mail and interface 31 can discontinue the off-hook condition. (If the caller hangs up prior to the user answering or prior to said answering machine or voice mail, interface 31 can respond by discontinuing the off-hook condition.)

In summary, the example of the fourth embodiment (FIG. 4) operates by: Step(1) providing caller I.D. information to a user; Step(2) receiving instruction from a user; Step(3) going off-hook in response to the instruction received; Step(4) sending a stored who-message to a caller in response to the instruction received; Step(5) receiving who-information from a caller; Step(6) Providing at least one signal to operate an information deliverer to deliver who-information to a user.

A fifth embodiment of telephone call handling system 10 is illustrated in FIG. 5. This fifth embodiment comprises caller I.D. circuitry 20 (described prior). This embodiment also comprises call-announce circuitry configured to attain what/why-information 70, and initiator 94 (initiator 94 described prior).

An example of call-announce circuitry configured to attain what/why-information 70 (FIG. 5) will now be given. Call-announce circuitry 70 functions to answer a telephone call and attain call-announce information input by a caller and to provide at least one signal to deliver at least some of the attained information to a user. Call-announce circuitry 70 comprises interface 31 (described prior), out-going message sender 32 (described prior), information signal provider 85 (described prior) and incoming information receiver 95 (described prior).

An example of this fifth embodiment is illustrated as system 10h in FIG. 5. Out-going message sender 32 of call-announce circuitry 70 is configured to store and to provide to a caller a what/why-message 102. What/why-message 102 states (for example), “What may I say you are calling about?”

U.I. 99 of initiator 94 is configured to receive instruction from a user via a control button Why 105, Why 105 electrically connected to (or connectable to) line 11a and located at telephone 27h. When pressed, Why 105 sends a control signal to U.I. 99. U.I. 99 responds by sending a signal to interface 31 and, after a two-second delay, by sending a signal to sender 32. Interface 31 responds by going off-hook. Sender 32 responds by sending what/why-message 102 to the caller.

An example of operation of this example of this fifth embodiment will now be given. A user's telephone is rung by an incoming ring signal from station 120 via line 11 and line 11a. Delivered with the ring signal is caller I.D. information. The information appears on display 21 (telephone 27h). The user recognizes the phone number on the display; i.e. the user is mostly certain that his good friend Monte is calling. However, the user is extremely busy and doesn't have time for small talk.

Therefore, the user presses button Why 105. Why 105 sends a control signal to U.I. 99. U.I. 99 responds by sending a signal to interface 31 and, after a two-second delay, by sending a signal to sender 32. Interface 31 responds by going off-hook. Sender 32 responds by sending what/why-message 102, “What may I say you are calling about?” to the caller. The caller then states, “I need my basketball back”. Information receiver 95 receives the stated information and forwards the information to information signal provider 85. Provider 85 forwards the information to telephone receiver 86 of information deliverer 100 via line 11a. Receiver 86 emits, “I want my basketball back”. The user hears the response, doesn't care to deal with this right now and doesn't answer the call. (After a given amount of delay, the call can be forwarded to a voice mail system, or other.)

In summary, the example of the fifth embodiment (FIG. 5) operates by: Step(1) providing caller I.D. information to a user; Step(2) receiving instruction from a user; Step(3) going off-hook in response to the instruction received; Step(4) sending a stored what/why-message to a caller in response to the instruction received; Step(5) receiving what/why-information from a caller; Step(6) Providing at least one signal to operate an information deliverer to deliver what/why-information to a user.

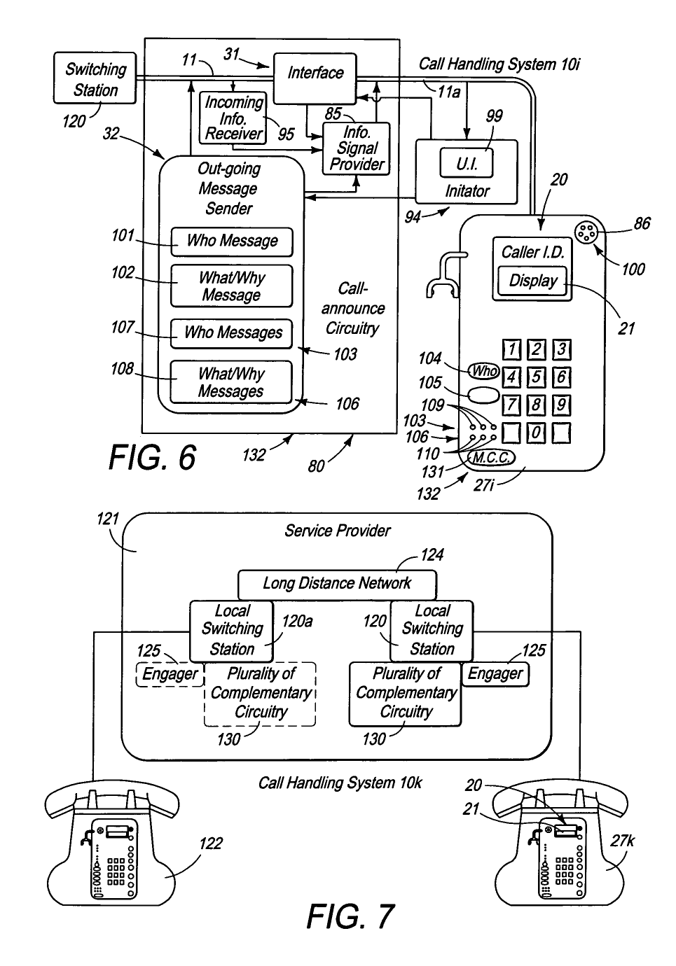

A sixth embodiment of telephone call handling system 10 is illustrated in FIG. 6. This sixth embodiment comprises caller I.D. circuitry 20 (described prior). This embodiment also comprises call-announce circuitry configured to attain who-information and what/why-information 80, and an initiator 94 (initiator 94 described prior).

An example of call-announce circuitry configured to attain who-information and what/why-information 80 (FIG. 6), will now be given. Call-announce circuitry 80 functions to answer a telephone call and attain call-announce information input by a caller and to provide at least one signal to deliver at least some of the attained information to a user. Call-announce circuitry 80 comprises interface 31 (described prior), out-going message sender 32 (described prior), information signal provider 85 (described prior) and incoming information receiver 95 (described prior).

An example of this sixth embodiment is illustrated as system 10i in FIG. 6. Message sender 32 of call-announce circuitry 80 is configured to store and to provide to a caller who-message 101. Sender 32 is further configured to store and to provide to a caller what/why-message 102. When sent to a caller, who-message 101 provides to ask the caller to identify him or her self. When sent to a caller, what/why-message 102 provides to ask the caller the purpose of the call.

U.I. 99 of initiator 94 is configured to receive instruction from a user via control button Who 104 and, also, via control button Why 105, Who 104 and Why 105 each electrically connected to (or connectable to) line 11a and located at telephone 27i. When pressed, Who 104 sends a control signal to U.I. 99. When pressed, Why 105 sends a control signal to U.I. 99. U.I. 99 responds to each signal, respectively, by sending a signal to interface 31. After a two-second delay, U.I. 99 further responds to each by sending a signal to sender 32. Interface 31 responds by going off-hook. Sender 32 responds to pressed button Who 104 by sending who-message 101 to the caller. Sender 32 responds to pressed button Why 105 by sending what/why-message 102 to the caller.

An example of operation of this first example of this sixth embodiment will now be given. A user's telephone is rung by an incoming ring signal provided by station 120 via line 11 and line 11a. Delivered with the ring signal is caller I.D. information. Display 21 shows a telephone number and name foreign to the user. The user presses button Who 104. Who 104 sends a control signal to U.I. 99. U.I. 99 responds by sending a signal to interface 31 and, after a two-second delay, by sending a signal to sender 32. Interface 31 responds by going off-hook. Sender 32 responds by sending who-message 101, “Whom may I say is calling?” to the caller. The caller then states his name, “Mike Pimple”. Information receiver 95 receives the stated “Mike Pimple” information and forwards the information to information signal provider 85. Provider 85 forwards the information to telephone receiver 86 of information deliverer 100 via line 11a. Receiver 86 emits “Mike Pimple”.

The user does not recognize this person. And so, the user then presses Why 105. Sender 32 responds by sending what/why-message 102, “What may I say you are calling about?” to the caller. The caller then states, “I heard you were shopping for life insurance”. Information receiver 95 receives the stated information and forwards the information to information signal provider 85. Provider 85 forwards the information to telephone receiver 86 (and/or loudspeaker 87) of information deliverer 100 via line 11 a. Receiver 86 emits, “I heard you were shopping for life insurance”. The user doesn't care to talk with this person and, therefore, does not answer the call. After a given amount of delay, the call can be forwarded to a voice mail system, or other. (Alternately, the user can choose to press Who 104 but not followed by pressing Why 105. Alternately, the user can choose to press Why 105 followed by pressing What 104, or can choose to press Why 105 only.)

This sixth embodiment can be configured with additional features serving to enhance performance. Said features comprise plurality of who messages 103 and plurality of what/why messages 106, shown in FIG. 6.

As an example, plurality of who-messages 103 comprises who-messages 107 located at sender 32 and who-buttons 109 located at telephone 27i. Plurality of what/why-messages 106 comprises what/why-messages 108 located at sender 32 and why-buttons 110 located at telephone 27i. Out-going message sender 32 is configured to play and send to a caller one of who-messages 107. Message sender 32 is configured to play and send to a caller one of what/why messages 108. Who-buttons 109 and why-buttons 110 are each electrically connected to (or connectable to) line 11a and each sends a control signal to U.I. 99 when pressed.

Plurality of who-messages 103 and plurality of what/why-messages 106 each can be configured to operate as described for plurality of call back messages 38 (FIG. 1b) or as described for plurality of hold messages 74 (FIG. 2b). In other words, each pressed button of buttons 109 serves to instruct sender 32 (via line 11a and U.I. 99) to send the corresponding message from who-messages 107 to the caller. Each pressed button of buttons 110 serves to instruct sender 32 (via line 11a and U.I. 99) to send the corresponding message from what/why-messages 108 to the caller. (The fourth embodiment (FIG. 4) can further comprise plurality of who messages 103. The fifth embodiment (FIG. 5) can further comprise plurality of what/why messages 106.)

In summary, the example of the sixth embodiment (FIG. 6) operates by: Step(1) providing caller I.D. information to a user; Step(2) receiving instruction from a user; Step(3) going off-hook in response to the instruction received; Step(4) sending a stored who-message and/or sending a stored what/why-message to a caller in response to the instruction received; Step(5) receiving who-information and/or what/why-information from a caller; Step(6) Providing at least one signal to operate an information deliverer to deliver who and/or what/why information to a user.

Call announce circuitry configured to attain who information 60 and/or call announce circuitry configured to attain what/why information 70 can be configured to operate in conjunction with conventional telephone hardware to comprise a missed-call announce 132 shown in FIG. 6. As an example, missed-call announce 132 functions to provide call announce information to a user relative to a missed-call. For this example, the conventional hardware comprises a missed call circuitry M.C.C. 131, circuitry 131 shown located at telephone 27i in FIG. 6 and at telephone 27j in FIG. 8. M.C.C. 131 is configured such that a user can select a missed call from M.C.C. 131 and the telephone will dial the number of the missed call. As an example of operation, the user scrolls through a list supplied by M.C.C. 131 as displayed on display 21 and selects a missed call. The user then presses button Who 104 followed by a conventional telephone hardware telephone talk button. M.C.C. 131 responds to the pressed talk button by dialing the selected missed-call number. When the telephone of the missed-call number is answered, interface 31 responds to the answering, as instructed by pressed button Who 104, by signaling message sender 32 (signaling shown in FIG. 8). Sender 32 responds by waiting three seconds and then playing a who-message such as, “Whom may I say has recently called 652-8834 (user's phone number)?” The response from the missed caller's telephone is then delivered to the user as prior described for the operation of call announce circuitry configured to attain who information 60.

Call handling system 10 can be bundled with an advertiser (A.) 128 shown in FIG. 8. As an example, A. 128 functions to advertise a telephone manufacturer or service provider. For example, call back message C.B. A 33 states, “Please call back in one hour”. When bundled with advertiser 128, C.B. A 33 may then state, “Rayphone, please call back in one hour”. (Advertiser 128 can also be bundled with C.B. B 34, C.B. C 35, each of specific-time messages 36: 1-9 & 01-09, E. 49, H.M. A 71, H.M. B 72, H.M. C 73, each of storage 98 E. Picks: 1-9 & 01-09, Who-message 101, What/why-message 102, each of Who messages 107, each of What/why messages 108, or other.)

A seventh embodiment of telephone call handling system 10 is illustrated in FIG. 8. This seventh embodiment comprises caller I.D. circuitry 20 (described prior). This embodiment also comprises a plurality of complementary circuitry 130 and an engager 125.

An example of plurality of complementary circuitry 130 (FIG. 8) will now be given. Plurality of complementary circuitry 130 functions to provide a plurality of complementary circuitry for a user to selectively engage. When engaged, a complementary circuitry sends a response to the source of an incoming call, the source as identified (or not) by caller I.D. 20.

Plurality of complementary circuitry 130 comprises: call back message circuitry 30 (FIGS. 1a and 1b); message-then-hold circuitry 40 (FIGS. 2a and 2b); concert circuitry 50 (FIGS. 3a and 3b); call announce circuitry configured to attain who-information 60 (FIG. 4), and call-announce circuitry configured to attain what/why-information 70 (FIG. 5).

An example of engager 125 (FIG. 8) will now be given. Engager 125 functions to receive instruction from a user to selectively engage one or more of plurality of complementary circuitry 130. Engager 125 provides the prior described functionality of activator 91, starter 92, orchestrator 93 and initiator 94. Engager 125 comprises user interface (U.I.) 99. U.I. 99 functions to receive instruction from a user. (Circuitry 130 and engager 125 can comprise common-day telephony components.)

An example of this seventh embodiment is illustrated as call handling system 10j in FIG. 8. This embodiment comprises a combining of the examples of handling system 10 illustrated in FIGS. 1a, 1b, 2a, 2b, 3a, 3b, 4 and 5.

But one example of operation of this seventh embodiment will now be given. A user's telephone is rung by an incoming ring signal provided by station 120 via line 11 and line 11a. Delivered with the ring signal is caller I.D. information. Display 21 shows a telephone number and name recognized by the user as his friend Bud's cell phone. Plurality of complementary call handling circuitry 130 is available for the user to selectively engage via the associated buttons located on telephone 27j. The user is quite busy and, therefore, chooses between sending a call back message to the caller (call back message circuitry 30, FIGS. 1a and 1b), placing the caller on hold (message-then-hold circuitry 40, FIGS. 2a and 2b) or attain what/why-information from the caller (call announce circuitry configured to attain what/why-information 70, FIG. 5). (Because the user is quite busy and mostly certain that Bud is calling, the user does not see deploying call announce circuitry configured to attain who-information 60 as an option at this time. Because the user is quite busy, deploying concert circuitry 50 is also not an attractive option at this time.) The user decides to send a call back message to the caller. The user presses button 44. Button 44 sends a control signal to U.I. 99. U.I. 99 responds by sending a signal to interface 31 and, after a two-second delay, by sending a signal to sender 32. Interface 31 responds by going off-hook. Sender 32 responds by sending C.B. B 34, “Please call back tomorrow” to the caller. The caller hears the message and understands to call the user back on the following day. At the conclusion to the sending of the message, message sender 32 sends a signal to interface 31. Interface 31 responds by discontinuing the off-hook condition. (Interface 31 can respond to a caller hang-up by discontinuing the off-hook condition.)

This seventh embodiment can be enhanced with a rapid-fire (R.F.) 140. R.F. 140 is shown located at sender 32 in FIG. 8 and functions to enable a next choice to be chosen from the one or more plurality of complementary circuitry 130 at will.

An example of this seventh embodiment (FIG. 8) enhanced with R.F. 140 will now be given. One of plurality of complementary circuitry 130 has been engaged prior and is presently being employed. Upon receiving a signal from a pressed control button, U.I. 99 of engager 125 is configured to engage a next choice of complementary circuitry (of plurality of complementary circuitry 130), the next choice of complementary circuitry engaged immediately. Upon receiving a signal from a pressed-for-duration control button, U.I. 99 of engager 125 is configured to engage a next choice of complementary circuitry (of plurality of complementary circuitry 130), the next choice of complementary circuitry engaged upon conclusion to the operation of the prior engaged complementary circuitry.

But one example of operation of this seventh embodiment enhanced with rapid-fire 140 will now be given. A user's telephone receives an incoming ring signal from station 120 via line 11 and line 11a. Delivered with the ring signal is caller I.D. information. The caller I.D. information appears on display 21 (telephone 27j). The user recognizes the phone number on the display; i.e. the user is certain that the call is from his friend Molly's cell-phone. However, the user is extremely busy and, also, feeling just a bit playful. The user initially presses control button 43. Pressed button 43 implements call back message circuitry 30 (as depicted in FIGS. 1a and 1b). C.B. A 33 is sent to the caller, stating “Please call back in one hour”. However, before the sending of the message has concluded, the user presses control button 82. Pressed button 82 immediately engages message-then-hold circuitry 40 (as depicted in FIG. 2b.) H.M. B 72 is sent to the caller, stating “Hold your horses, I'll be there in a jiffy”. Sender 32 then plays and sends entertainment E. 49 to the caller. Handling system 10h remains idle (on hold, maintaining the off-hook condition) while E. 49 continues to be played and sent to the caller. After a period of time, the user presses the EP 79 button and presses key-5 of keypad 47. Pressed button EP 79 followed by pressed key-5 immediately engages E. Picks 76. Sender 32 responds by discontinuing the playing and sending of E. 49 and by playing and sending to the caller the music stored as pick-5 in pick storage 98 (as depicted in FIG. 2b). The caller then hears the picked music and may enjoy. Sender 32 continues playing and sending the music as handling system 10d remains idle (on hold). A little while later, the user presses the EP 79 button and presses key-8 of keypad 47. Sender 32 responds by immediately discontinuing the prior music and by playing and sending the music stored as pick-8 in pick storage 98. The caller then hears this next choice of picked music and may enjoy. Sender 32 continues playing and sending the music as handling system 10d remains idle (on hold).

After a minute or two, the user presses control button Who 104. Pressed button Who 104 immediately engages call-announce circuitry configured to attain who-information 60 (as depicted in FIG. 4). Who-message 101 is sent to the caller, stating “Whom may I say is calling?” The response from the caller, “This is Molly” is attained and sent to the user. The user responds to the who-information by pressing control button Why 105. Pressed button Why 105 immediately engages call-announce circuitry configured to attain what/why-information 70 (as depicted in FIG. 5). What/why-message 102 is sent to the caller, stating “What may I say you are calling about?” The caller responds by stating something about her sick dog, but before the user hears the whole message, the user presses-for-duration control button C 84. The user then presses button EP 79 followed by key-0 and then key-4. Pressed-for-duration button C 84 engages concert circuitry 50 (as depicted in FIG. 3b). Upon the conclusion to the prior attaining of the what/why-information from the caller (when Molly has finished her message), E. Pick-04 is then played and sent to both the caller and user. Both caller and user then enjoy the sound of a hoot owl mating. Some 30 seconds later, the user presses button EP 79 and then presses key-6. Immediately, sender 32 discontinues the sound of the hoot owl mating and plays and sends E. Pick-6 to both caller and user. Both caller and user then enjoy the user's new “Rock Fish” single. Some 50 seconds later, the user decides to press control button Who 104. Pressed button Who 104 immediately engages call-announce circuitry configured to attain who-information 60 (as depicted in FIG. 4). Who message 101 is sent to the caller, stating “Who may I say is calling?” The response from the caller, “Its Molly!” is attained and delivered to the user. Then the caller hangs up. (Interface 31 can respond to the caller hang-up by discontinuing the off-hook condition.)

In summary, the example of the seventh embodiment (FIG. 8) operates by: Step(1) providing caller I.D. information to a user; Step(2) providing a plurality of complementary circuitry for a user to engage; Step(3) receiving instruction from a user; Step(4) going off-hook in response to the instruction received; Step(5) engaging one of the plurality of complementary circuitry in response to the instruction received; Step(6) sending a stored message to a caller, the stored message associated with the one of the plurality of complementary circuitry.

Each of activator 91 (FIGS. 1a & 1b), starter 92 (FIGS. 2a and 2b), orchestrator 93 (FIGS. 3a and 3b), initiator 94 (FIGS. 4; 5 and 6) and engager 125 (FIG. 8) can be more generally described as an outgoing information handler. Thus, in response to receiving instruction from a user via telephone 27, the outgoing information handler generates an instruction to interface 31 to go off-hook and to out-going message sender 32 to send information to the caller.

A further embodiment provides for a telephony system having a user telephone that can receive telephone calls. The user telephone includes a display device and a caller identification circuit configured to display on the display device a caller identification identifying a source of a call to the user telephone. The system also includes a plurality of pre-recorded user-selectable responses. The telephony system includes circuitry to allow the user to select, via the user telephone, one of the user-selectable responses based on the user viewing the source of the call as displayed on the display device. The system further includes circuitry to transmit the response selected by the user to be received at the source of the call.

A further embodiment provides for a telephony system, having a user telephone that can receive telephone calls. The user telephone includes a display device and a caller identification circuit configured to display on the display device a caller identification identifying a source of a call to the user telephone. The system also includes a plurality of user-selectable complementary circuitry. The telephony system includes circuitry to allow the user to select, via the user telephone, one of the user-selectable complementary circuitry based on the user viewing the source of the call as displayed on the display device. The system further includes circuitry to transmit a response from the one of the user-selected complementary circuitry.

A further embodiment provides for a telephony system for use with a user telephone, the user telephone enabled to receive telephone calls and display a caller identification to a user of the user telephone on a display device, the caller identification identifying a source of a call to the user. The system includes a plurality of pre-recorded user selectable responses and circuitry to allow the user to select, via the user telephone, one of the user-selectable responses based on the user viewing the source of the call as displayed on the display device. The system further includes circuitry to transmit the response selected by the user to the source of the call.

Described prior information configured to be sent to the caller by sender 32 can include one or more of: C.B. A 33, C.B. B 34, C.B. C 35, each of specific-time messages 36: 1-9 & 01-09, E. 49, H.M. A 71, H.M. B 72, H.M. C 73, each of storage 98 E. Picks: 1-9 & 01-09, Who-message 101, What/why-message 102, each of Who messages 107, each of What/why messages 108, stored advertisement T.Z. 136, each of advertiser picks A.P. 137. Said described prior information can be initially pre-loaded into sender 32 by a service provider or telephony equipment manufacturer or other. Said described prior information can be initially, and/or subsequently, loaded into sender 32 by a user. Said information can be re-selected and again loaded into sender 32, re-selecting to include selecting a new/next/subsequent choice of information to load. A user can load information from any number of sources such as: libraries on the internet via a computer or a WiFi connection (if system 10 is WiFi enabled), a music player, a recording device, libraries stored in handling system 10 itself or libraries stored at service provider 121. (Said libraries on the internet may be found on a service provider web site, a telephone manufacturer web site, a music web site or other. The information can also be stored on one or more memory devices which can be made accessible to the user via a service provider.)

The apparatus described herein can be implemented using known circuits and a programmable processor along with a computer-readable memory containing a series of computer executable instructions which can be executed by the processor. For example, the apparatus can include telephony circuits for transmitting caller information (e.g., caller I.D.) to the called-phone, telephony circuits for establishing a communication link from a called-phone to a caller phone, telephony circuits for transmitting a stored message to a caller, telephony circuits for establishing a direct communication connection between a caller and a called party, telephony circuits for communicating attained information from a caller to a called party, and telephony circuits for generating an off-hook signal.

The computer executable instructions (stored in the computer-readable memory and executable by the programmable processor) can include a series of executable steps to perform the following: present a menu of selection options to a user via a graphical user display of messages and/or information to be provided to a calling party; receive an input (or instruction) from a user (i.e., a called party) via a user interface (e.g., a keyboard or a graphical user interface), use the received input to determine a specific message or information to be transmitted to a calling party; enable telephony circuitry to establish a telephonic communication connection with the called party and implement telephonic transmission of the specific message or information to the calling party; and enable a user to store in the computer-readable memory a series of user-selected messages and/or information to be potentially later communicated to a caller, and enable the user to label the stored messages and/or information such as with descriptive titles for later reference by the user.

It will be appreciated that the apparatus of the present disclosures has been described by examples (FIGS. 1a-8) of telephonic equipment (specifically, handset or telephone 27) which provide buttons for implementing various user-selection options described herein. (For example, telephone 27b of FIG. 1b provides buttons 43, 44 and 45 which allow a user to select various call-back messages.) However, when a user handset or telephone is provided with a graphical user interface (GUI), then the user can be provided with hierarchical menus in place of buttons. For example, if the telephone 27j of FIG. 8 is provided with a GUI instead of the indicated buttons (48, 97, 104, 105, et seq.), the first menu (upon indication of an incoming call) can display to the user the following: the caller I.D. (if known), and two touch-screen selections as follows: “answer call” or “options”. Selection of “answer call” allows the user (or called party) to answer the call, while selection of “options” presents to the user a new screen on the GUI offering the user the following options: “call back”, “hold”, “concert” and “get more info”. Selection of the “hold” option presents to the user a new screen on the GUI offering the user the following options: “please hold”, “hold for one minute”, or such other “hold” menu options as a user may program into the handset. (Failure to select one of the “hold” options can cause a default “hold” message to be sent to the caller.)

Likewise, by selecting the “call back” option, the user is presented (via the GUI) a new menu with the following options: “call back later”, “call back in 1 hour”, “call back in select time”, “never call back”, and such other “call back” menu options as a user may program into the handset. By selecting “call back in select time” the user can be presented with a keypad menu to allow the user to enter the time in minutes, hours or days to be sent to the caller specifying when the caller should call back. In like manner, by selecting the “get more info” option from the initial-call menu, a secondary menu can be presented to the user allowing the user to select a “who” or “what/why” message to be sent to the caller. Each menu can also be provided with “answer” or “end call” options should the user change his or her mind during the menu selection process (e.g., if the user decides after selecting the “call back” menu option that the user would instead prefer to take the call at that time, the user can select the “answer” option on the presently-presented menu screen).

Further, the music and/or sound options described herein can be provided as additional menu options. For example, in the “hold” menu one option can be “hold with entertainment”. The “hold with entertainment” option can provide another menu of entertainment options, including “default music”, “default sound”, “selected music”, “selected sound”, “pick music”, “pick sound”, and “live streaming radio”. By selecting any one of the “pick music”, “pick sound”, and “live streaming radio” menu options, a further (respective) menu is presented to the user allowing the user to select the respective music, sound or radio station to be provided to the caller during the hold period. (The “live streaming radio” menu option assumes that the users handset allows for wireless internet connectivity.) Said menu presented to the user allowing the user to select the respective music, sound or radio station can provide the selections on the display as icons, pictures, graphics or other, representative of said music, sound or radio station. For example, a sound choice may be a train whistle and, therefore, a graphic of an antique steam locomotive is presented on the display/screen.

It is understood that the above examples of the various embodiments provided for herein can be implemented using alternative means and structures to provided essentially equivalent functionality, and that the scope of the present invention is not to be limited by these examples. For example, the specific content of messages which can be provided to a caller by the systems described herein can vary from the given examples, without varying from the general scope of a respective embodiment. Further, the functionality provided by the interface 31 (i.e., of generating an off-hook signal in order to enable outgoing transmissions of information to the caller) can be accomplished using other known circuitry and/or software implementations. In general, the systems described herein include circuitry and/or software implementations to enable information to be sent to a caller telephone without necessarily placing the called phone in a call-answered condition. In one variation, and in response to a command from a user to send information to a caller based on the user's review of the caller-ID (or lack thereof), the systems described herein use existing voice message circuitry to enable the user-selected information to be sent to the caller's telephone. That is, the incoming call is answered, but communication is enabled only from the messaging sending circuitry to the caller (and potentially from the caller to the user, in the case of “who” and “what/why” requested information), and only bilaterally between the caller and the user once the user answers the call. In another variation, information described herein that is to be sent to a caller in the form of a verbal message (e.g., “I'll be with you in one minute”, or “Please call back in 30 minutes”) can be sent to the caller by the message sender 32 in the form of a text message, provided the caller's telephone has text-message capability.

Handling systems 10a through 10j can reside with and as the property of the telephone user as illustrated in FIGS. 1a through 6 and FIG. 8. Alternately, handling system 10k lends benefit to the user but is provided by telephone service provider 121 as illustrated in FIG. 7. As an example, handling system 10k comprises handling system 10j of FIG. 8 oriented such that plurality of complementary circuitry 130 and engager 125 are located at switching station 120 while the various control buttons and caller I.D. display 21 remain located at telephone 27k. (Handling system 10k can comprise substantially different circuitry than the examples of system 10a through 10j shown in FIGS. 1a through 6 and FIG. 8.)

The embodiments of telephone call handling system 10 herein disclosed in FIGS. 1a through 6 and FIG. 8 are shown as functional when located between service provider 121 and telephone 27 with control buttons and display 21 located at telephone 27. The embodiment of system 10 disclosed in FIG. 7 is shown functional when located at service provider 121, FIG. 7, with control buttons and display 21 located at telephone 27k. Additionally, system 10 can be located otherwise. (Telephone 27 can comprise a corded landline telephone, a cellular telephone, a cordless landline phone, or other) For example, system 10 can be located entirely at telephone 27 with control buttons and display 21 also located at telephone 27. For example, system 10 can be located in-part at the base of a cordless telephone and in-part at the cordless telephone itself For example, system 10 can be located in-part at a service provider 121, in-part located between service provider 121 and telephone 27 and with control buttons and display 21 located at telephone 27. For example, system 10 can be located in-part at a service provider 121 and in-part located between service provider 121 and telephone 27, with control buttons and display 21 located between service provider 121 and telephone 27 and with control buttons and display located at telephone 27. For example, system 10 can be located in-part at a service provider 121, in-part located between service provider 121 and telephone 27, in-part at telephone 27 and with control buttons and display 21 located at telephone 27. For example, service provider 121 can provide phone service along with cable television service. A television screen can then comprise display 21 and system 10 can be located at telephone 27. Telephone 27 can be electrically connected to (or connectable to) a cable control box (user's home) and control buttons can be located at telephone 27 and, also, can be located on a remote control associated with the cable box (or other cable/phone configurations).

I claim:

1. A telephony system for use with a user telephone, the user telephone enabled to receive telephone calls and display a caller identification to a user of the user telephone on a display device, the caller identification identifying a source of a call to the user, the system comprising:
a plurality of pre-recorded user selectable responses;
circuitry to allow the user to select, via the user telephone, one of the user-selectable responses based on the user viewing the source of the call as displayed on the display device; and
circuitry to transmit the response selected by the user to be received at the source of the call.

2. The system of claim 1 and wherein the circuitry to allow the user to select one of the user-selectable responses, and the circuitry to transmit the response selected by the user, can be enabled independent of the user answering the call.

3. The system of claim 1 and further comprising circuitry to go off-hook in response to the user selecting one of the plurality of user-selectable responses.

4. The system of claim 3 and wherein the circuitry to go off-hook is further configured to at least one of return to an on-hook condition or, maintain the off-hook condition until the user answers the call.

5. The system of claim 1 and wherein the plurality of pre-recorded user-selectable responses comprises at least one of: a call back message, a specific-time call back message, a hold message, a content message-then-hold message a specific-time hold message, an entertainment or a Tiser message.

6. The system of claim 1 and wherein the plurality of pre-recorded user-selectable responses comprises at least one of: a plurality of call back messages, a plurality of specific-time call back messages, a plurality of hold messages, a plurality of specific-time hold messages, a plurality of entertainment or a plurality of Tiser messages.

7. The system of claim 1 and wherein the circuitry to allow the user to select one of the user-selectable responses comprises at least one of: call back message circuitry, message-then-hold circuitry, concert circuitry, call announce circuitry configured to attain who information or call announce circuitry configured to attain what/why information.

8. The system of claim 1 and wherein at least one of: the circuitry to allow the user to select one of the user-selectable responses, or, the circuitry to transmit the response selected by the user, is located at a service provider.

9. The system of claim 1 and wherein at least one of: the circuitry to allow the user to select one of the user-selectable responses, or, the circuitry to transmit the response selected by the user, is located at the user telephone.

10. A telephony system for use with a user telephone, the user telephone enabled to receive telephone calls and display a caller identification to a user of the user telephone on a display device, the caller identification identifying a source of a call to the user, the system comprising:
a plurality of user-selectable complementary circuitry for a user to engage;
circuitry to allow the user to select, via the user telephone, one of the plurality of complementary circuitry based on the user viewing the source of the call as displayed on the display device; and
circuitry to transmit a response from the one of the user-selectable complementary circuitry to be received at the source of the call.

11. The system of claim 10 and wherein the circuitry to allow the user to select one of the user-selectable complementary circuitry, and the circuitry to transmit a response from the one of the plurality of user-selectable complementary circuitry, can be enabled independent of the user answering the call.

12. The system of claim 10 and further comprising circuitry to go off-hook in response to the user selecting one of the plurality of user-selectable complementary circuitry.

13. The system of claim 12 and wherein the circuitry to go off-hook is further configured to at least one of: return to an on-hook condition or, maintain the off-hook condition until the user answers the call.

14. The system of claim 10 and wherein the plurality of complementary circuitry comprises at least one of: call back message circuitry, message-then-hold circuitry, concert circuitry, call announce circuitry configured to attain who information or call announce circuitry configured to attain what/why information.

15. The system of claim 10 and wherein at least one of the plurality of complementary circuitry provides a plurality of responses for a user to pick from.

16. The system of claim 15 and wherein the plurality of responses comprises one of: a plurality of call back messages, a plurality of specific-time call back messages, a plurality of hold messages, a plurality of specific-time hold messages, a plurality of entertainment or a plurality of Tiser messages

17. The system of claim 10 and wherein the response from the one of the user-selectable complementary circuitry comprises one of: a call back message, a specific-time call back message, a hold message, a specific-time hold message, a content message-then-hold message, a user-selected entertainment, a user-picked entertainment or a Tiser message.

18. The system of claim 10 and wherein at least one of: the circuitry to allow the user to select one of the user-selectable complementary circuitry, or, the circuitry to transmit a response from the one of the plurality of user-selectable complementary circuitry, is located at a service provider.

19. The system of claim 10 and wherein at least one of: the circuitry to allow the user to select one of the user-selectable complementary circuitry, or, the circuitry to transmit a response from the one of the plurality of user-selectable complementary circuitry, is located at the user telephone.

20. A telephony method comprising:
providing caller I.D. information to a user;
providing a plurality of complementary circuitry for a user to engage;
receiving instruction from a user based on the caller I.D. information;
engaging one of the plurality of complementary circuitry in response to the instruction received; and
sending a pre-recorded message from the one of the plurality of complementary circuitry to be received at a source of the call.
